(19) United States
(12) Patent Application Publication
(10) Pub. No.: US 2012/0331020 A1
(43) Pub. Date: Dec. 27, 2012

(54) MOBILE TERMINAL APPARATUS, INFORMATION OUTPUT SYSTEM, INFORMATION OUTPUT METHOD AND RECORDING MEDIUM

(76) Inventor: Taichiro Morishita, Osaka-shi (JP)

(21) Appl. No.: 13/574,992

(22) PCT Filed: Mar. 14, 2011
(86) PCT No.: PCT/JP2011/055981

§ 371 Date: Jul. 24, 2012

(30) Foreign Application Priority Data
Mar. 15, 2010 (JP) 2010-058514

(51) Int. Cl. G06F 17/30

(52) U.S. Cl. 707/822; 707/E17.01

(57) ABSTRACT

An information output system is provided. A DLNA server, if any folder name includes a date or an event name, registers, as publication files, the files included in a detected folder with a DB in date ascending order, and, if any folder name includes neither any date nor any event name, registers, as publication files, the files included in a detected folder with the DB in date descending order. When a first communication section receives, from a DLNA client, a folder information request of a folder name selected by a remote controller, a content list, which is a list of the file names of the files included in the folder of the selected folder name, is created, and the created content list is then transmitted by the first communication section to the DLNA client.

### TECHNICAL FIELD

The present invention relates to a mobile terminal apparatus capable of displaying stored image information on other apparatus such as a display apparatus, an information output system, an information output method and a recording medium.

### BACKGROUND ART

A device connected to a network enables to display and browse a plurality of pictures saved in the device on other device on the same network. For example, the device connected to the network stores a picture as a file of image data and information such as a shooting time and a tile of the picture is added to the file. The device connected to the network arranges pictures based on the information in the order from the one whose time and date of photography is the oldest or the most recent, or in the order of titles of pictures, for example, in the order of index such as the order of Japanese syllabary or the alphabetical order, to transmit to other device on the network sequentially for allowing display and browsing.

For example, as a first related art, there is a service providing system described, in Patent Literature 1. In this service providing system, a diary service providing server creates a Web page based on image data of an image shot by a network video camera, and in response to an operation from an information terminal apparatus, adds information related to shooting time and date and a shooting place when and where the image was shot to the image data as a diary. The information terminal apparatus displays a diary list of the user created by the diary service providing server on a display, and by selecting an item of a desired date from the displayed diary list, the user is able to browse a diary file of the selected date sequentially. The diary file includes a thumbnail of image data and a diary.

As a second related art, there is an image processing server described in Patent Literature 2. This image processing server creates a home page of an album for browsing based on a still image or a moving image uploaded on the image processing server, and transmits only highly favorable images in the order of popularity based on a voting result of a popularity vote by a mobile terminal to the mobile terminal for display.

As a third related art, there is an image processing apparatus described in Patent Literature 3. This image processing apparatus stores an image data file for each operator as well as stores a history data file indicating a history that image data is used for each group to which an operator belongs. When an operator searches a file used by other operator in the same group, the image processing apparatus displays the history data file of the group to which the operator who searches the file belongs in accordance with the priority order, so that the operator is able to find the desired file easily therefrom.

As a fourth related art, there is an image forming apparatus described in Patent Literature 4. This image forming apparatus has a plurality of applications and a plurality of communication protocol daemons provided for each communication protocol, and each application transmits and receives data to and from a network through a communication protocol daemon of a communication protocol that transmits and receives data such as printing data or image data.

As a fifth related art, there is a data processing apparatus described in Patent Literature 5. This data processing apparatus, when displaying information indicating a device connected to a network on a screen, displays a device having a server function with an icon having a form that means having the server function based on a management table created in advance. Alternatively, a license server and a client with a license are displayed with respective icons.

### CITATION LIST

### Patent Literatures

Patent Literature 1: Japanese Unexamined Patent Publication JP-A 2004-32129
Patent Literature 2: Japanese Unexamined Patent Publication JP-A 2004-70614
Patent Literature 3: Japanese Unexamined Patent Publication JP-A 2006-80747
Patent Literature 4: Japanese Unexamined Patent Publication JP-A 2004-1425
Patent Literature 5: Japanese Unexamined Patent Publication JP-A 2001-109551

However, the first related art is such that a Web page is created based on image data of a shot image so that a thumbnail and a diary are able to be browsed sequentially by operating the information terminal apparatus, the second related art is such that a home page of an album for browsing is created based on a still image or a moving image that is uploaded and images are displayed in the order of popularity by operating the mobile terminal, and it is impossible to cause a plurality of pictures as a list be browsed in both related arts. In addition, though the third related art is such that a history data file is displayed in accordance with the priority order, but it is impossible to change the order of files displayed as a list in response to a type of a file or a folder.

The fourth related art is such that transmission and reception of data is controlled, the fifth related art is such that a device having a server function among devices connected to the network is displayed with a predetermined icon, and the fourth and fifth related arts are not to control display of data such as printing data or image data.

In the first to third related arts, browsing has to be performed in accordance with the predetermined order, and there is a problem that, for example, even a plurality of files with the story line such as pictures of a birthday party or the like have to be seen not in the chronological order but in the reverse chronological order, or ones desired to be seen in the reverse chronological order have to be seen in the chronological order.

### SUMMARY OF INVENTION

An object of the invention is to provide a mobile terminal apparatus capable of easily changing an outputting order when data of images or the like is outputted to other apparatus connected to a network, an information output system, an information output method and a recording medium.

The invention provides a mobile terminal apparatus comprising a storage section that stores a plurality of output data sets to be outputted by an output apparatus for outputting data, associated with output data identification information for identifying the plurality of output data sets so that the plurality of output data sets are sorted into a plurality of folders to which individual folder identification information are added, as well as stores folder identification information of the respective folders,

a first transmitting section that reads folder identification information stored in the storage section and transmits the read folder identification information to the output apparatus,

a receiving section that receives folder identification information selected from among the folder identification information transmitted by the first transmitting section from the output apparatus,

a generating section that reads output data identification information of the output data sets sorted into a folder shown by the folder identification information received by the receiving section and generates an output data list in which the read output data identification information is arranged in accordance with arranging order determined based on received folder identification information, and

a second transmitting section that transmits the output data list generated by the generating section to the output apparatus.

According to the invention, a storage section stores a plurality of output data sets to be outputted by an output apparatus for outputting data, associated with output data identification information for identifying the plurality of output data sets so that the plurality of output data sets are sorted into a plurality of folders to which individual folder identification information are added, as well as stores folder identification information of the respective folders. A first transmitting section reads folder identification information stored in the storage section and transmits the read folder identification information to the output apparatus. A receiving section receives folder identification information selected from among the folder identification information transmitted by the first transmitting section from the output apparatus. A generating section reads output data identification information of the output data sets sorted into a folder shown by the folder identification information received by the receiving section and generates an output data list in which the read output data identification information is arranged in accordance with arranging order determined based on the received folder identification information. In addition, a second transmitting section transmits the output data list generated by the generating section to the output apparatus.

Accordingly, it is possible to control the order that output data sets are outputted in accordance with information included in folder identification information, for example, a folder name, thus making it possible to change outputting order easily when data of an image or the like is outputted to other apparatus connected to a network.

Further, in the invention, it is preferable that the storage section stores time and date information indicating times and dates when the respective output data sets are generated,

the folder identification information stored in the storage section has folder identification information including date information indicating a date when an output data set is generated and folder identification information not including date information, and

when the received folder identification information includes date information, the generating section generates an output data list in which the output data identification information is arranged in ascending order of times and dates shown by the time and date information stored in the storage section,

and when the received folder identification information does not include date information, the generating section generates an output data list in which the output data identification information is arranged in descending order of times and dates shown by the time and date information stored in the storage section.

According to the invention, the storage section stores time and date information indicating times and dates when the respective output data sets are generated. The folder identification information stored in the storage section has folder identification information including date information indicating a date when an output data set is generated and folder identification information not including date information. In addition, when the received folder identification information includes date information, the generating section generates an output data list in which the output data identification information is arranged in ascending order of times and dates shown by the time and date information stored in the storage section, and when the received folder identification information does not include date information, the generating section generates an output data list in which the output data identification information is arranged in descending order of times and dates shown by the time and date information stored in the storage section. Accordingly, by including a date, for example, a year-month-day in folder identification information, for example, a folder name, it is possible to display output data sets included in the folder in the generating order.

Further, in the invention, it is preferable that the storage section stores time and date information indicating times and dates when the respective output data sets are generated,

the folder identification information stored in the storage section has folder identification information including event name information indicating an event name and folder identification information not including event name information, and

when the received folder identification information includes event name information, the generating section generates an output data list in which the output data identification information is arranged in ascending order of times and dates shown by the time and date information stored in the storage section,

and when the received folder identification information does not include event name information, the generating section generates an output data list in which the output data identification information is arranged in descending order of times and dates shown by the time and date information stored in the storage section.

According to the invention, the storage section stores time and date information indicating times and dates when the respective output data sets are generated. The folder identification information stored in the storage section has folder identification information including event name information indicating an event name and folder identification information not including event name information. In addition, when the received folder identification information includes event name information, the generating section generates an output data list in which the output data identification information is arranged in ascending order of times and dates shown by the time and date information stored in the storage section, and when the received folder identification information does not include event name information, the generating section generates an output data list in which the output data identification information is arranged in descending order of times and dates shown by the time and date information stored in the storage section. Accordingly, by including an event name in folder identification information, for example, a folder name, it is possible to display output data sets included in the folder in the generating order and the story line is not failed.

Further, in the invention, it is preferable that the folder identification information stored in the storage section has folder identification information including keyword information indicating a keyword and folder identification information not including keyword information, and

when the received folder identification information includes keyword information, the generating section generates an output data list in which the output data identification information is arranged in arranging order determined based on the keyword information.

According to the invention, the folder identification information stored in the storage section has folder identification information including keyword information indicating a keyword and folder identification information not including keyword information. When the received folder identification information includes keyword information, the generating section generates an output data list in which the output data identification information is arranged in arranging order determined based on the keyword information, so that by including a keyword in folder identification information, for example, a folder name, it is possible to display output data sets included in the folder in the generating order or reverse order of the generating order.

Further, in the invention, it is preferable that the storage section stores manufacturer identification information for identifying manufacturers that produced mobile terminal apparatuses, and

arranging order determined based on the received folder identification information is set based on the manufacturer identification information stored in the storage section.

According to the invention, the storage section stores manufacturer identification information for identifying manufacturers that produced mobile terminal apparatuses. In addition, arranging order determined based on the received folder identification information is set based on the manufacturer identification information stored in the storage section, so that it is possible to perform display in the different displaying order for each mobile terminal with different manufacturer.

Further, in the invention, it is preferable that the output data set stored in the storage section includes image data indicating an image, and

the mobile terminal apparatus further comprises an image display section that displays image data sorted into a folder indicated by folder identification information selected from the folder identification information stored in the storage section in arranging order determined based on a predetermined basis that is different from the arranging order determined based on the received folder identification information.

According to the invention, the output data set stored in the storage section includes image data indicating an image. In addition, an image display section displays image data sorted into a folder indicated by folder identification information selected from the folder identification information stored in the storage section in arranging order determined based on a predetermined basis that is different from the arranging order determined based on the received folder identification information. Accordingly, it is possible to set the displaying order of the image display section such as a photo viewer independently.

Further, the invention provides an information output system comprising an output apparatus that outputs data, and a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders,

the output apparatus displaying the folder information stored in the mobile terminal apparatus and selecting folder identification information of a folder to be outputted from the displayed folder identification information,

the mobile terminal apparatus generating an output data list in which output data identification information of the output data sets sorted into the folder shown by the folder identification information selected by the output apparatus in accordance with arranging order determined based on the selected folder identification information, and

the output apparatus sequentially outputting the output data sets in arranging order arranged in the output data list generated by the mobile terminal apparatus.

According to the invention, when outputting information in an information output system comprising an output apparatus that outputs data, and a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders, the output apparatus displays the folder information stored in the mobile terminal apparatus and selects folder identification information of a folder to be outputted from the displayed folder identification information. The mobile terminal apparatus generates an output data list in which output data identification information of the output data sets sorted into the folder shown by the folder identification information selected by the output apparatus in accordance with arranging order determined based on the selected folder identification information. In addition, the output apparatus sequentially outputs the output data sets in arranging order arranged in the output data list generated by the mobile terminal apparatus.

Accordingly, it is possible to control the order that output data sets are outputted in accordance with information included in folder identification information, for example, a folder name, thus making it possible to change the outputting order easily when data of an image or the like is outputted to other apparatus connected to a network.

Further, the invention provides an information output method executed in an information output system including an output apparatus that outputs data, and a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders, comprising

a selection step where the output apparatus displays folder information stored in the mobile terminal apparatus and selects folder identification information of a folder to be outputted from the displayed folder identification information,

a generation step where the mobile terminal apparatus generates an output data list in which output data identification information of the output data sets sorted into the folder shown by the folder identification information selected at the selection step is arranged in accordance with arranging order determined based on the selected folder identification information, and

an output step where the output apparatus sequentially outputs the output data sets in arranging order arranged in the output data list generated at the generation step.

According to the invention, when outputting information in an information output system including an output apparatus that outputs data, and a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders, at a selection step, the output apparatus displays folder information stored in the mobile terminal apparatus and selects folder identification information of a folder to be outputted from the displayed folder identification information. At a generation step, the mobile terminal apparatus generates an output data list in which output data identification information of the output data sets sorted into the folder shown by the folder identification information selected at the selection step is arranged in accordance with arranging order determined based on the selected folder identification information. In addition, at an output step, the output apparatus sequentially outputs the output data sets in arranging order arranged in the output data list generated at the generation step.

Accordingly, it is possible to control the outputting order of the output data sets in accordance with information included in folder identification information, for example, a folder name, thus making it possible to change outputting order easily when data of an image or the like is outputted to other apparatus connected to a network.

Further, the invention provides a computer readable recording medium having a program recorded therein for causing a computer included in an information output system including an output section that outputs data, a storage section that stores a plurality of output data sets to be outputted by the output section, associated with output data identification information for identifying the plurality of output data sets so that the plurality of output data sets are sorted into a plurality of folders to which individual folder identification information are added, as well as stores folder identification information of the respective folders, and the computer, to execute

a selection step of displaying folder information stored in the storage section and selecting folder identification information of a folder to be outputted from the displayed folder identification information,

a generation step of generating an output data list in which output data identification information of the output data sets sorted into the folder shown by the folder identification information selected at the selection step is arranged in accordance with arranging order determined based on the selected folder identification information, and

an output step of sequentially outputting the output data sets in arranging order arranged in the output data list generated at the generation step on the output section.

According to the invention, it is possible to provide as a computer readable recording medium having a program recorded therein for causing a computer included in an information output system including an output section that outputs data, a storage section that stores a plurality of output data sets to be outputted by the output section, associated with output data identification information for identifying the plurality of output data sets so that the plurality of output data sets are sorted into a plurality of folders to which individual folder identification information are added, as well as stores folder identification information of the respective folders, and the computer, to execute a selection step of displaying folder information stored in the storage section and selecting folder identification information of a folder to be outputted from the displayed folder identification information, a generation step of generating an output data list in which output data identification information of the output data sets sorted into the folder shown by the folder identification information selected at the selection step is arranged in accordance with arranging order determined based on the selected folder identification information, and an output step of sequentially outputting the output data sets in arranging order arranged in the output data list generated at the generation step on the output section.

### BRIEF DESCRIPTION OF DRAWINGS

FIG. 1 is a block diagram showing a configuration of an image display system according to one embodiment of the invention;

FIG. 2 is a block diagram showing a configuration of a mobile terminal;

FIG. 3 is a block diagram showing a configuration of a display apparatus;

FIG. 4 is a view showing an external appearance of the mobile terminal;

FIG. 5 is a view showing an external appearance of the display apparatus;

FIG. 6 is a view showing an external appearance of a remote controller;

FIG. 7A is a view for explaining DLNA setting in the mobile terminal;

FIG. 7B is a view for explaining DLNA setting in the mobile terminal;

FIG. 7C is a view for explaining DLNA setting in the mobile terminal;

FIG. 7D is a view for explaining DLNA setting in the mobile terminal;

FIG. 7E is a view for explaining DLNA setting in the mobile terminal;

FIG. 7F is a view for explaining DLNA setting in the mobile terminal;

FIG. 7G is a view for explaining DLNA setting in the mobile terminal;

FIG. 7H is a view for explaining DLNA setting in the mobile terminal;

FIG. 7I is a view for explaining DLNA setting in the mobile terminal;

FIG. 8 is a view showing an example of a directory structure of data recorded in an SD card;

FIG. 9A is a view showing a first example of operation procedure for displaying a picture by the display apparatus;

FIG. 9B is a view showing a first example of operation procedure for displaying a picture by the display apparatus;

FIG. 9C is a view showing a first example of operation procedure for displaying a picture by the display apparatus;

FIG. 9D is a view showing a first example of operation procedure for displaying a picture by the display apparatus;

FIG. 9E is a view showing a first example of operation procedure for displaying a picture by the display apparatus;

FIG. 9F is a view showing a first example of operation procedure for displaying a picture by the display apparatus;

FIG. 9G is a view showing a first example of operation procedure for displaying a picture by the display apparatus;

FIG. 9H is a view showing a first example of operation procedure for displaying a picture by the display apparatus;

FIG. 10A is a view showing a second example of operation procedure for displaying a picture by the display apparatus;

FIG. 10B is a view showing a second example of operation procedure for displaying a picture by the display apparatus;

FIG. 10C is a view showing a second example of operation procedure for displaying a picture by the display apparatus;

FIG. 10D is a view showing a second example of operation procedure for displaying a picture by the display apparatus;

FIG. 11A is a view showing a third example of processing procedure for displaying a picture by the display apparatus;

FIG. 11B is a view showing a third example of processing procedure for displaying a picture by the display apparatus;

FIG. 11C is a view showing a third example of processing procedure for displaying a picture by the display apparatus;

FIG. 11D is a view showing a third example of processing procedure for displaying a picture by the display apparatus;

FIG. 12A is a view showing a fourth example of operation procedure for displaying a picture by the display apparatus;

FIG. 12B is a view showing a fourth example of operation procedure for displaying a picture by the display apparatus;

FIG. 12C is a view showing a fourth example of operation procedure for displaying a picture by the display apparatus;

FIG. 13 is a view showing a DB data structure;

FIG. 14 is a view showing a data structure of a content list;

FIG. 15A is a flowchart showing processing procedure of first DLNA setting processing executed by the mobile terminal;

FIG. 15B is a flowchart showing processing procedure of first DLNA setting processing executed by the mobile terminal;

FIG. 16A is a flowchart showing processing procedure of first content list transmission processing executed by the mobile terminal and processing procedure of first content list request processing executed by the display apparatus, associated with each other;

FIG. 16B is a flowchart showing processing procedure of first content list transmission processing executed by the mobile terminal and processing procedure of first content list request processing executed by the display apparatus, associated with each other;

FIG. 17A is a flowchart showing processing procedure of image transmission processing executed by the mobile terminal and processing procedure of image display processing executed by the display apparatus, associated with each other;

FIG. 17B is a flowchart showing processing procedure of image transmission processing executed by the mobile terminal and processing procedure of image display processing executed by the display apparatus, associated with each other;

FIG. 18A is a flowchart showing processing procedure of second DLNA setting processing executed by the mobile terminal;

FIG. 18B is a flowchart showing processing procedure of second DLNA setting processing executed by the mobile terminal; and

FIG. 19 is a flowchart showing processing procedure of second content list transmission processing executed by the mobile terminal and processing procedure of second content list request processing executed by the display apparatus, associated with each other.

### DESCRIPTION OF EMBODIMENTS

Description will hereinafter be given in detail for preferred embodiments of the invention with reference to drawings.

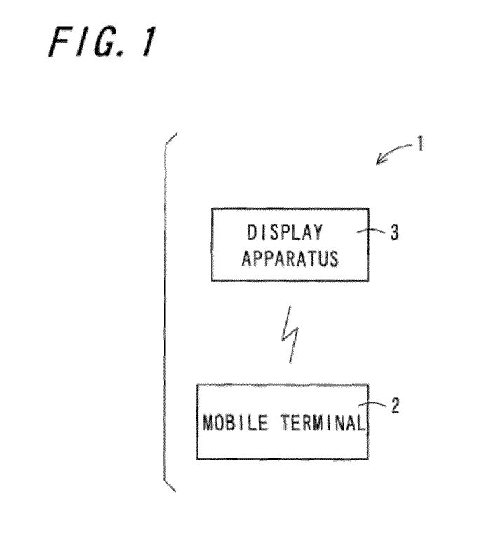

FIG. 1 is a block diagram showing a configuration of an image display system 1 according to one embodiment of the invention. An image display method according to the invention is executed by the image display system 1. The image display system 1 which is an information output system includes a mobile terminal apparatus (hereinafter referred to as a “mobile terminal”) 2 and a display apparatus 3.

The mobile terminal 2 and the display apparatus 3 are connected through a network such as a local area network (Local Area Network: abbreviated as LAN) or a wide area network (Wide Area Network: abbreviated as WAN). The mobile terminal 2 and the display apparatus 3 perform wireless communication, for example, by IEEE802.11g which is the wireless LAN communication standard. The wireless communication is not limited to wireless communication by the wireless LAN communication standard IEEE802.11g and may be wireless communication by the short distance wireless communication standard such as, for example, Bluetooth (registered trademark) or Zigbee (registered trademark).

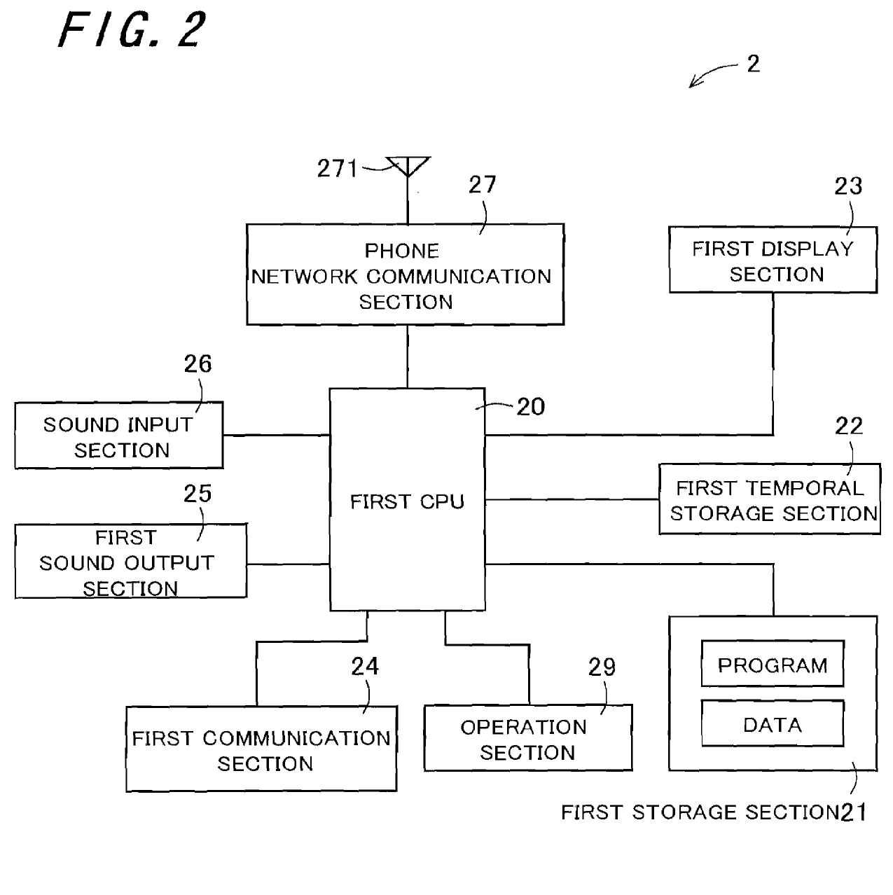

FIG. 2 is a block diagram showing a configuration of the mobile terminal 2. The mobile terminal 2 is configured by, for example, a mobile phone apparatus, a personal computer, a personal digital assistance (abbreviated as PDA), an electronic dictionary or the like. Description will be given below taking a mobile phone apparatus as an example of the mobile terminal 2.

The mobile terminal 2 includes a first central processing unit (Central Processing Unit: hereinafter referred to as “CPU”) 20, a first storage section 21, a first temporal storage section 22, a first display section 23, a first communication section 24, a first sound output section 25, a sound input section 26, a phone network communication section 27, an operation section 29 and a first antenna 271. The first CPU 20 executes a program stored in the first temporal storage section 22 to control the first display section 23, the first communication section 24, the first sound output section 25, the sound input section 26, the phone network communication section 27 and the operation section 29.

The first storage section 21 is configured by a storage apparatus such as, for example, a non-volatile semiconductor memory, is a storage apparatus that has larger capacity than that of the first temporal storage section 22, and stores a program executed by the first CPU 20 and data (hereinafter referred to also as “information”) needed for the control by the first CPU 20. The program stored in the first temporal storage section 22 includes an application program described below. Before executing a program, the first CPU 20 reads the program to be executed and information needed to execute the program from the first storage section 21 to write in the first temporal storage section 22 which is a storage section for storage. Then, the program stored in the first temporal storage section 22 is executed and processing such as calculation is performed for the information stored in the first temporal storage section 22. The first temporal storage section 22 is a storage apparatus configured by a semiconductor memory capable of reading and writing information at higher speed than the first storage section 21 or the like, and stores a program executed by the first CPU 20 and information processed by the first CPU 20.

The first display section 23 is configured by, for example, a liquid crystal display, and displays information received from the first CPU 20, for example, information indicating an operational status of the mobile terminal 2, or information needed to control the mobile terminal 2. The first communication section 24 is a communication apparatus for transmitting and receiving information to and from the display apparatus 3 and performs wireless communication, for example, by the wireless LAN communication standard IEEE802.11g. The first communication section 24 transmits information received from the first CPU 20 to the display apparatus 3 and provides information received from the display apparatus 3 to the first CPU 20. The first CPU 20 and the first communication section 24 are a first transmitting section, a receiving section and a second transmitting section. The first CPU 20 is a generating section.

The first sound output section 25 is configured by, for example, a speaker, and outputs information received from the first CPU 20, for example, sound information of verbal communication, or information for notification of an operational status as sound. The sound input section 26 is configured by, for example, a microphone and inputs sound and the like for verbal communication. The sound input section 26 converts the input sound into sound information to provide to the first CPU 20.

The phone network communication section 27 transmits and receives information by wireless communication through a public line network. The phone network communication section 27 converts information received from the first CPU 20, for example, information of sounds, packets or the like into electric signals to provide to the first antenna 271, and converts electric signals received from the first antenna 271 into information of sound, packets or the like to provide to the first CPU 20. The first antenna 271 outputs the electric signals received from the phone network communication section 27 as electric wave to transmit to a base station or the like, and receives the electric waves transmitted from the base station to convert into electric signals and provide to the phone network communication section 27. The operation section 29 is configured by, for example, a keyboard having an operation key, a touch panel or the like, and provides information input by a user with the operation key or the like for operating the mobile terminal 2 to the first CPU 20.

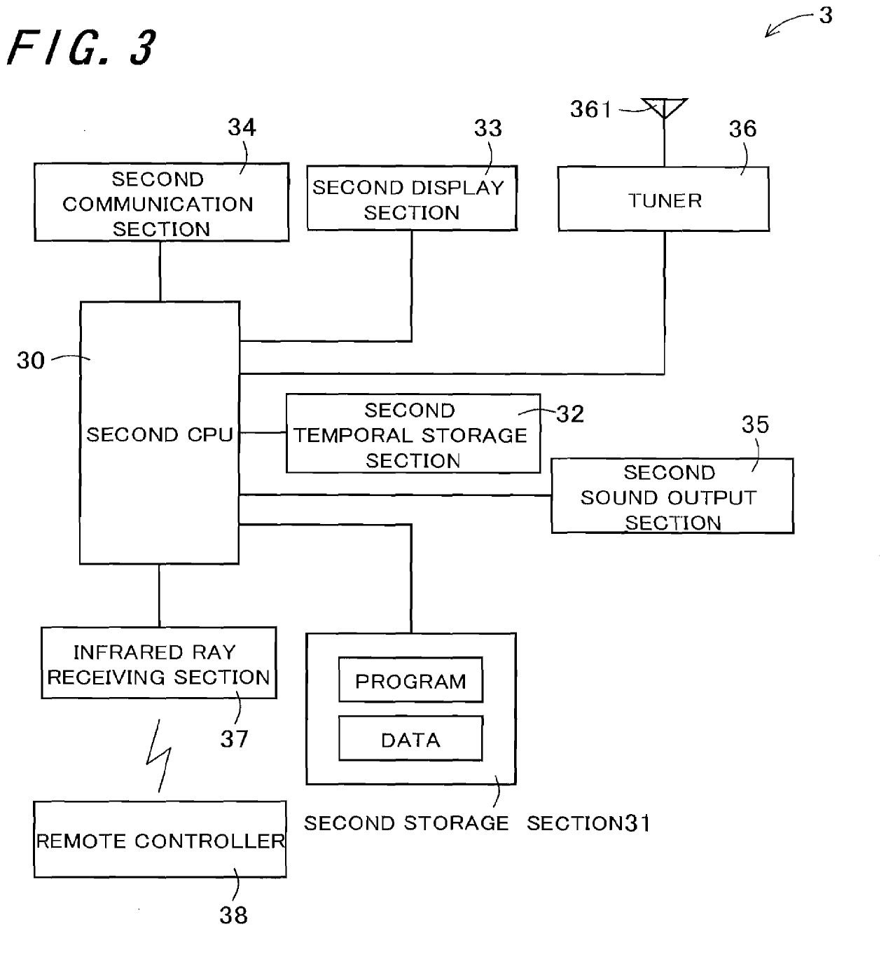

FIG. 3 is a block diagram showing a configuration of the display apparatus 3. The display apparatus 3 which is an output apparatus is configured by a car-mounted apparatus such as, for example, a television apparatus or a car navigation apparatus. Description will be given below taking a television apparatus as an example of the display apparatus 3.

The display apparatus 3 includes a second CPU 30, a second storage section 31, a second temporal storage section 32, a second display section 33, a second communication section 34, a second sound output section 35, a tuner 36, an infrared ray receiving section 37, a remote controller 38 and a second antenna 361. The second CPU 30 executes a program stored in the second temporal storage section 32 to control the second display section 33, the second communication section 34, the second sound output section 35, the tuner 36 and the infrared ray receiving section 37.

The second storage section 31 is configured by a storage apparatus such as, for example, a magnetic disk apparatus or a non-volatile semiconductor memory, and is a storage apparatus that has larger capacity than that of the second temporal storage section 32 and stores a program executed by the second CPU 30 and information needed for the control by the second CPU 30. Before executing a program, the second CPU 30 reads the program to be executed and information needed to execute the program from the second storage section 31 to write in the second temporal storage section 32 for storage. Then, the program stored in the second temporal storage section 32 is executed and processing such as calculation is performed for the information stored in the second temporal storage section 32.

The second temporal storage section 32 is a storage apparatus configured by a semiconductor memory capable of reading and writing information at higher speed than the second storage section 31 or the like, and stores a program executed by the second CPU 30 and information processed by the second CPU 30. The second display section 33 which is an output section is configured by, for example, a liquid crystal display, and displays information received from the second CPU 30, for example, image data indicating a picture or the like as an image or reproduces and displays moving image contents or the like.

The second communication section 34 is a communication apparatus for transmitting and receiving information to and from the mobile terminal 2 and performs wireless communication, for example, by the wireless LAN communication standard IEEE802.11g. The second communication section 34 transmits information received from the second CPU 30 to the mobile terminal 2 and provides the information received from the mobile terminal 2 to the second CPU 30. The wireless communication may not be performed directly with the mobile terminal 2 by a wireless LAN and it may be configured such that a wireless LAN access point is provided to connect the second communication section 34 to the wireless LAN access point by a wired LAN. That is, it is configured such that the display apparatus 3 performs communication with the wireless LAN access point by the wired LAN, and the wireless LAN access point and the mobile terminal 2 perform communication by the wireless LAN.

The second sound output section 35 is configured by, for example, a speaker and outputs information received from the second CPU 30, for example, sound information of a program receiving television broadcasting, sound information of moving image contents, or sound information of confirmation sound of operations by the remote controller 38 or the like as sound.

When a frequency of a channel selected by a user is informed from the second CPU 30, the tuner 36 receives electric waves of television broadcasting of the informed frequency by the second antenna 361, converts electric signals of the received television broadcasting into video information and sound information, and provides the converted video information and sound information to the second CPU 30. The second antenna 361 receives the electric waves of the television broadcasting to convert into electric signals and provide to the tuner 36.

The infrared ray receiving section 37 is a receiving apparatus for receiving infrared ray signals transmitted from the remote controller 38, and converts the received infrared ray signals into operation control information from the remote controller 38 and provides the converted operation control information to the second CPU 30. The remote controller 38 is a remote control apparatus having a plurality of operation keys for operating the display apparatus 3, and converts the operation control information instructed by the operation key into infrared ray signals to transmit to the display apparatus 3. The first CPU 20 and the second CPU 30 each is a computer.

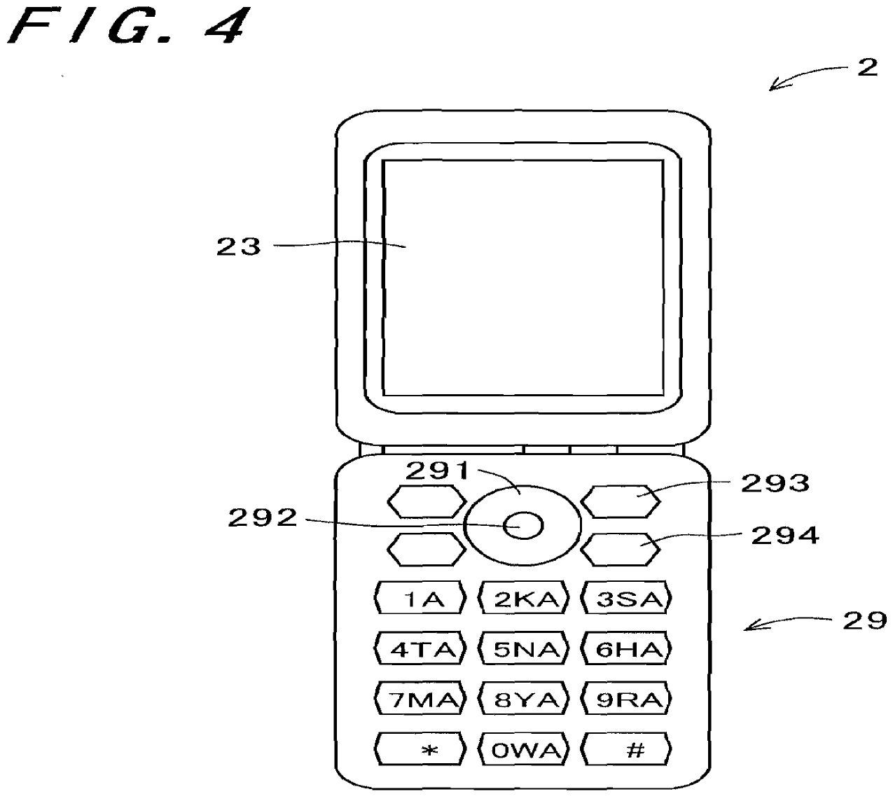

FIG. 4 is a view showing an external appearance of the mobile terminal 2. In the mobile terminal 2 shown in FIG. 4, the first display section 23 having a display screen and the operation section 29 having a plurality of operation keys are shown. The operation section 29 has operation keys such as a cursor key 291, an enter key 292, a back key 293 and an end key 294 in addition to the plurality of operation keys for inputting numbers, characters or codes.

The cursor key 291 is an operation key for moving a cursor displayed on the display screen of the first display section 23 vertically and horizontally. The enter key 292 is an operation key for instructing to select an item directed by the cursor. The back key 293 is an operation key for going back to a previous screen. The end key 294 is an operation key for instructing to end a function being executed.

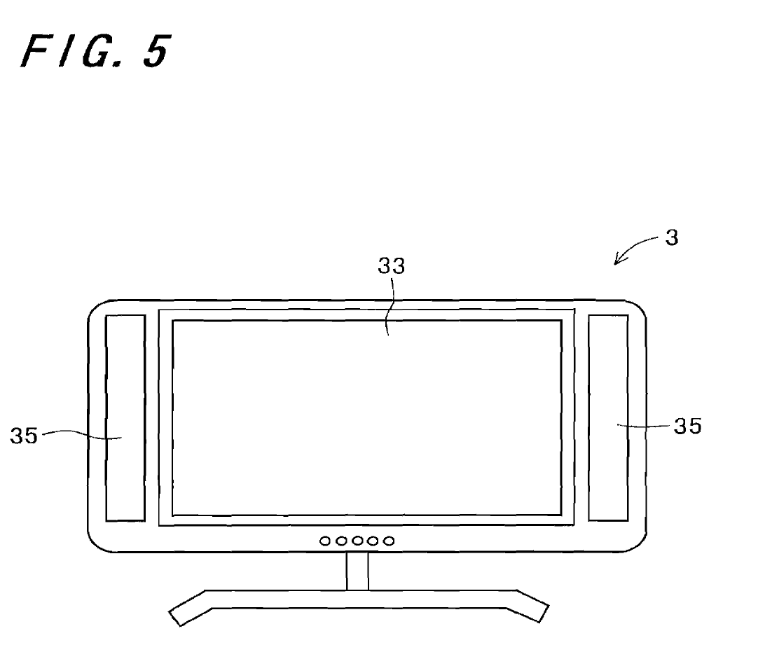

FIG. 5 is a view showing an external appearance of the display apparatus 3. In the display apparatus 3 shown in FIG. 5, the second display section 33 having a display screen and the second sound output sections 35 each having a speaker provided on both sides of the display screen are shown.

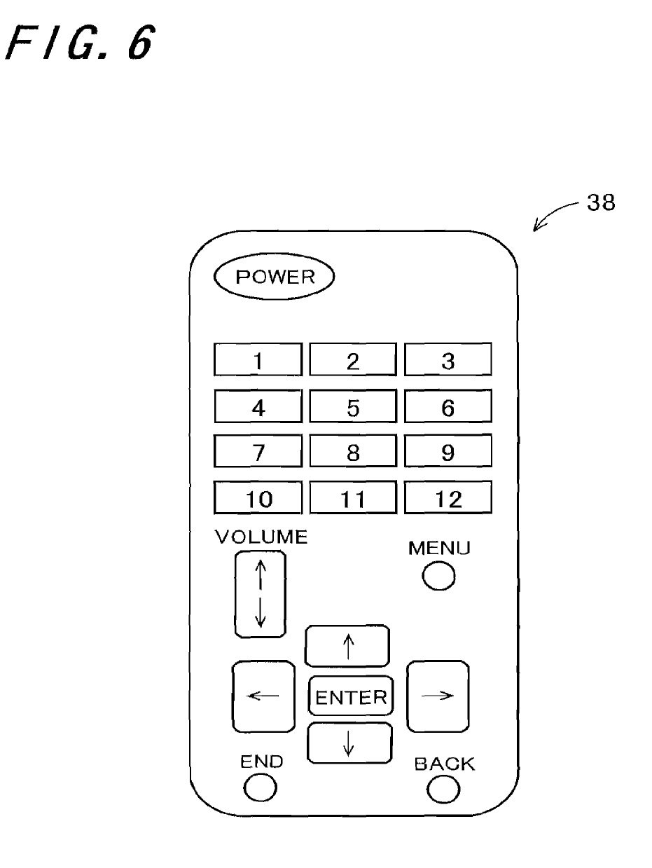

FIG. 6 is a view showing an external appearance of the remote controller 38. The remote controller 38 has operation keys such as a cursor key, an enter key, an end key, a back key and a red button (not shown), in addition to a power key for controlling on/off of the power of the display apparatus 3, a channel selection key in which channel numbers of “1” to “12” are shown, a volume adjustment key for adjusting volume and a menu key for displaying a menu.

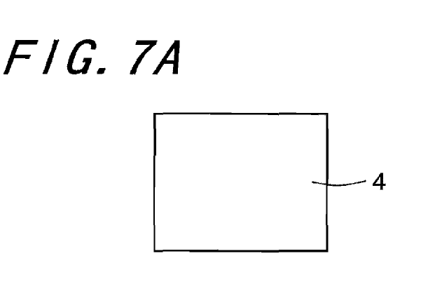

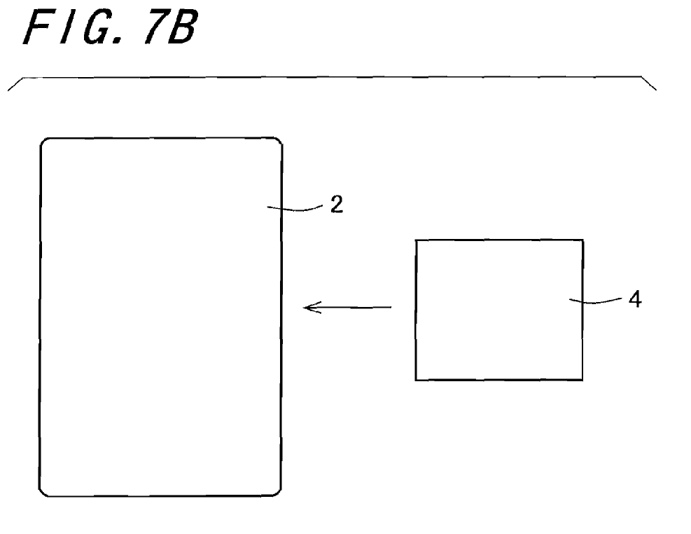

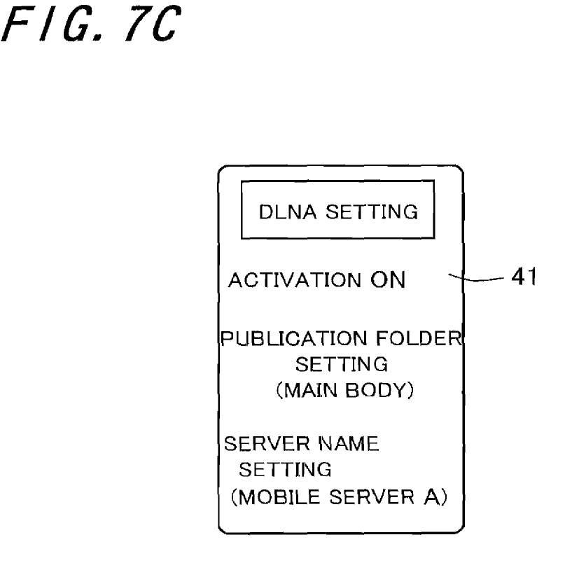

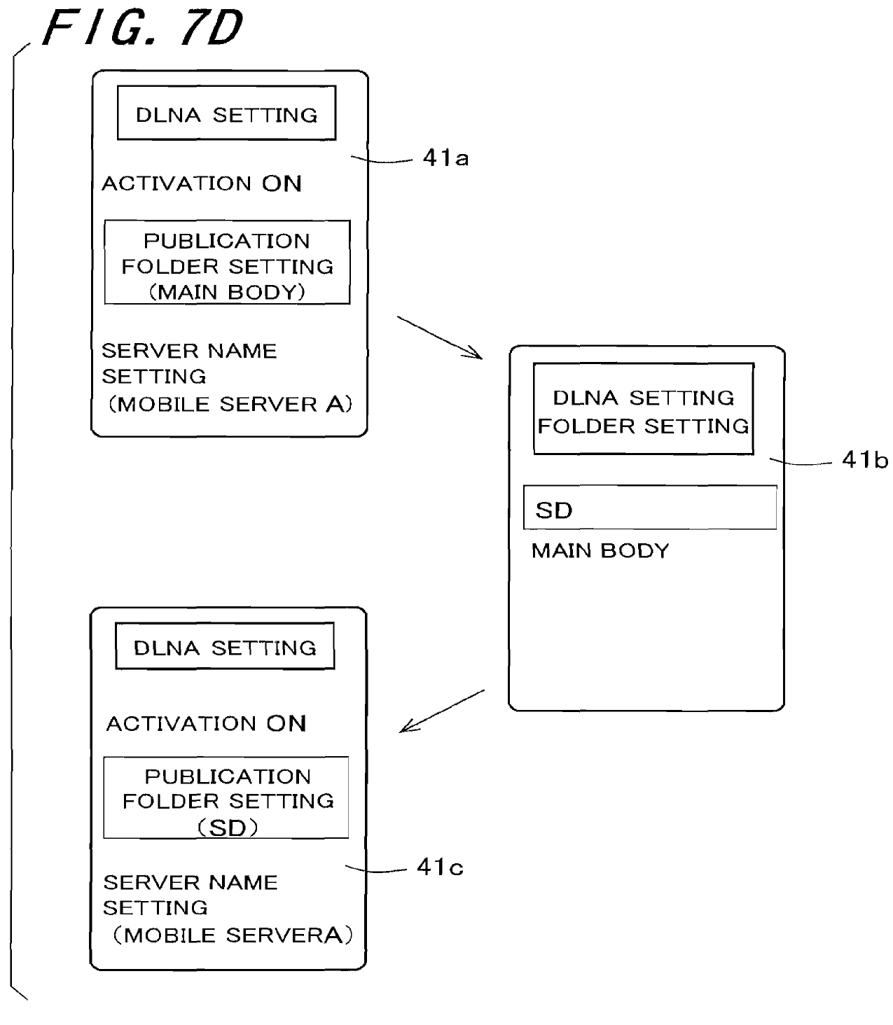

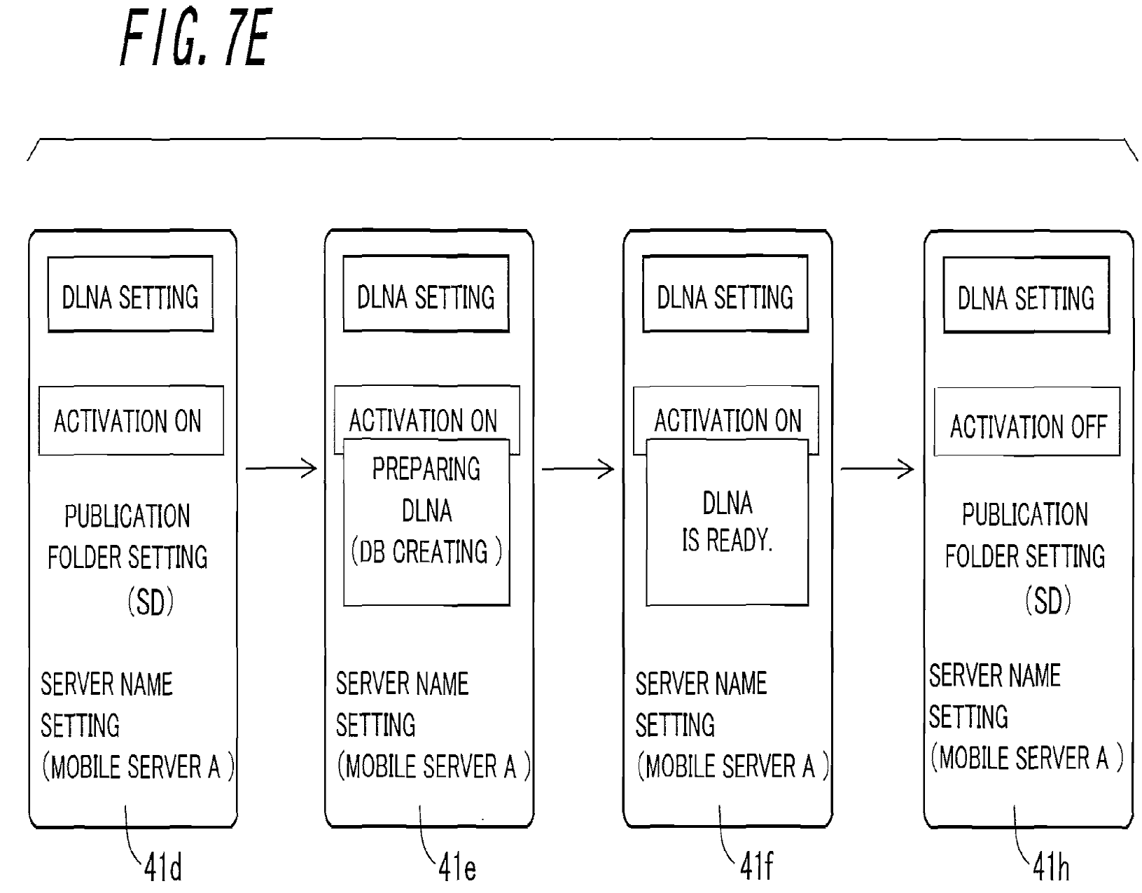

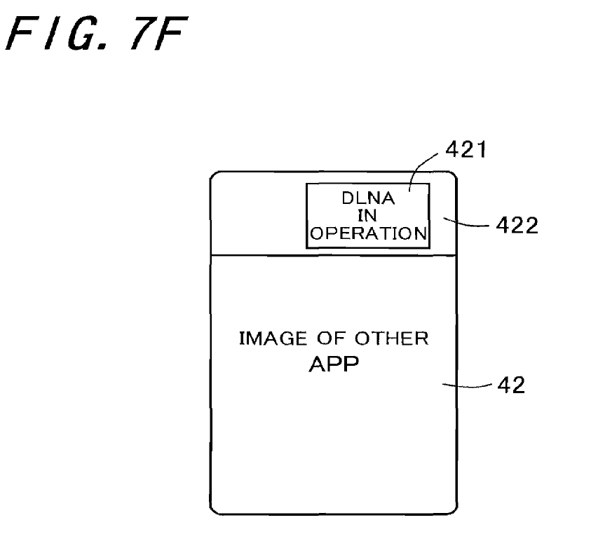

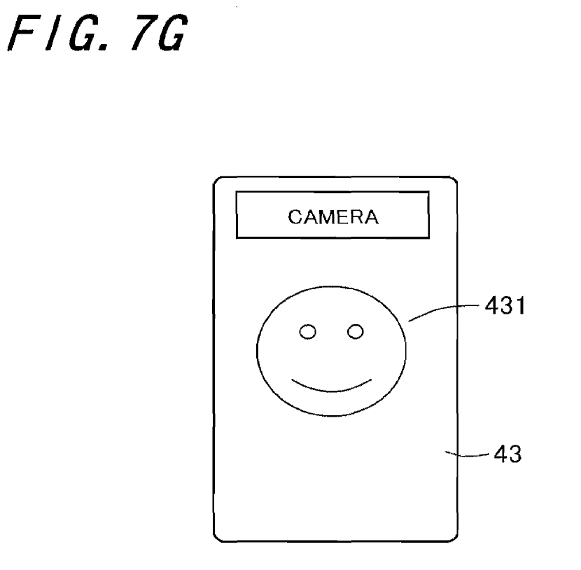

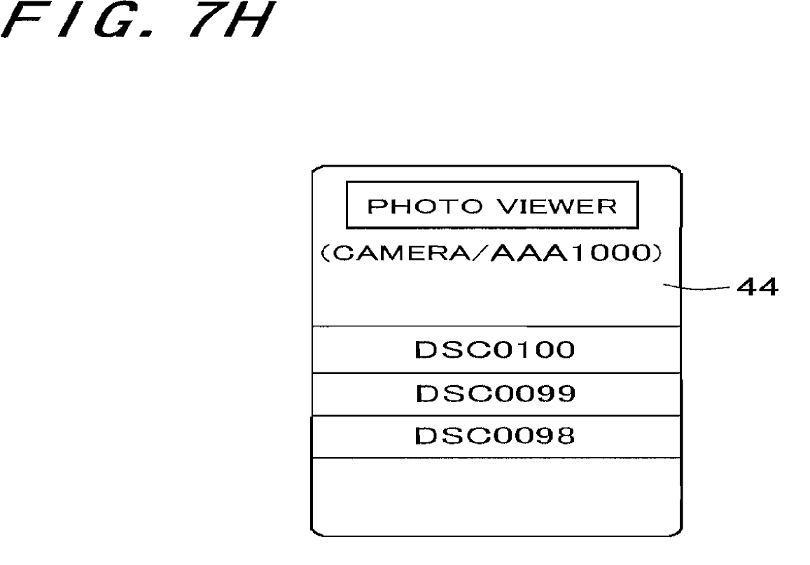

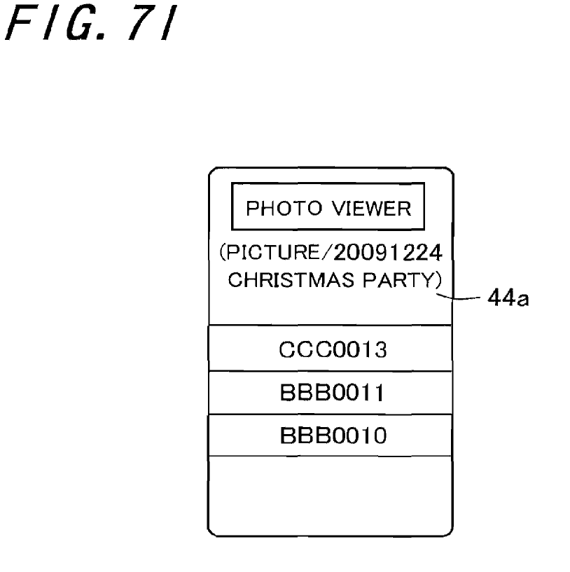

FIGS. 7A to 7I are views for explaining DLNA (Digital Living Network Alliance) setting in the mobile terminal 2. The DLNA setting is setting for causing the mobile terminal 2 to function as a DLNA server. The DLNA server is a server function embedded in the mobile terminal 2, which is a function realized when the first CPU 20 executes a program stored in the first temporal storage section 22. In response to a request from a client connected to a network, for example, a DLNA client, which will be described below, embedded in the display apparatus 3, the DLNA server provides a requested file to the DLNA client. The file to be provided is an electronic file of image data of a picture or the like, sound data of music or the like, moving image data of a moving image content or the like.

The DLNA server transmits and receives a file to and from the DLNA client in accordance with a protocol by the DLNA guideline defined by DLNA (Digital Living Network Alliance) as an industry association. In the present embodiment, file transfer between the server and the client is performed using the protocol by the DLNA guideline, but without limitation thereto, it is also possible to perform the transfer by other protocol.

FIG. 7A is a view for explaining that image data of a picture or the like to be published is prepared in an SD card 4. The SD card 4 is a transportable recording medium that is detachable, and is configured by, for example, an SD (Secure Digital) memory card. In the present embodiment, an SD memory card is used as the SD card 4, but without limitation thereto, may be a transportable recording medium that is detachable such as, for example, COMPACTFLASH (registered trademark).

The SD card 4 has publication data sets that are data sets to be published, such as image data of a picture or the like, sound data of music or the like, moving image data of a moving image content or the like, recorded therein in a file format by other information processing apparatus such as a personal computer. Hereinafter, publication data sets recorded in a file format are referred to as a publication file. Publication is outputting publication data sets that are output data sets to an output apparatus, for example, including displaying image data on the second display section 33 of the display apparatus 3, outputting music data from the second sound output section 35 of the display apparatus 3 as sound, and reproducing moving image data to display on the second display section 33 of the display apparatus 3, or outputting sound from the second sound output section 35 of the display apparatus 3 together with the display on the second display section 33 of the display apparatus 3.

FIG. 7B is a view for explaining that the SD card 4 is attached to the mobile terminal 2. The mobile terminal 2 further includes a recording medium attaching section which is not shown in FIG. 2, and when the SD card 4 is attached to the recording medium attaching section (not shown) of the mobile terminal 2, the first CPU 20 is able to read publication data sets recorded in the attached SD card 4. The publication data sets may be prepared, that is, stored in advance not only in the SD card 4 but in the first temporal storage section 22 of the mobile terminal 2. For example, when the mobile terminal 2 has a shooting apparatus such as a camera, the publication data sets stored in the first temporal storage section 22 may be image data of a picture shot by this camera or may be data copied from other SD card 4 attached to the mobile terminal 2 to the first temporal storage section 22. Though description will be given below mainly for publication of publication data sets recorded in the SD card 4, publication data sets stored in the first temporal storage section 22 of the mobile terminal 2 are also able to be published similarly.

FIG. 7C is a view showing an example of a DLNA setting screen 41. Specifically, when a user selects an item of DLNA setting from the menu displayed on the first display section 23 of the mobile terminal 2, a DLNA setting application that is an application program for performing DLNA setting is activated. The DLNA setting application is a function included in the DLNA server and the activated DLNA setting application displays the DLNA setting screen 41 on the first display section 23.

On the DLNA setting screen 41, a title of “DLNA SETTING”, and items of “ACTIVATION ON”, “PUBLICATION FOLDER SETTING” and “SERVER NAME SETTING” are displayed. The “ACTIVATION ON” is an item of “ACTIVATION ON/OFF FLAG” for instructing whether to activate the DLNA server or to stop activation, and shows that the item of the “ACTIVATION ON/OFF FLAG” is in the state for instructing to activate the DLNA server. When the cursor key 291 is operated and the cursor is pointed to the item of the “ACTIVATION ON” to operate the enter key 292, it is possible to activate the DLNA server. Operations for other items are performed similarly, and hereinafter, to operate the cursor key 291 and point the cursor to an item to operate the enter key 292 is simply referred to as to “select an item”.

The “PUBLICATION FOLDER SETTING” is an item for setting a folder whose data is to be published. When the item of the “PUBLICATION FOLDER SETTING” is selected, shifting is made to a DLNA setting folder setting screen 41b described below. The “SERVER NAME SETTING” is an item for setting a name of the DLNA server embedded in the mobile terminal 2. When the item of the “SERVER NAME SETTING” is selected, it becomes possible to set a name of the server by shifting to the server name setting screen.

On the DLNA setting screen 41 shown in FIG. 7C, “(MAIN BODY)” is displayed in the “PUBLICATION FOLDER SETTING” and “(MOBILE SERVER A)” is displayed in the “SERVER NAME SETTING”. The “(MAIN BODY)” in the “PUBLICATION FOLDER SETTING” shows that a folder whose publication data sets are to be published is a folder of a main body. The “MAIN BODY” refers to the main body of the mobile terminal 2, and shows that the folder of the first temporal storage section 22 of the mobile terminal 2 is set as the “PUBLICATION FOLDER SETTING”. The “(MOBILE SERVER A)” shows that the “MOBILE SERVER A” is set as a name of the DLNA server of the mobile terminal 2. When a plurality of DLNA servers are embedded in the mobile terminal 2, a name is applied to each of the DLNA servers, and the name of one of the DLNA servers selected therefrom is displayed.

FIG. 7D is a view for explaining setting of a publication folder. When the user selects the item of the “PUBLICATION FOLDER SETTING” on the DLNA setting screen 41a, the DLNA setting application changes the screen displayed on the first display section 23 of the mobile terminal 2 to the DLNA setting folder setting screen 41b. On the DLNA setting folder setting screen 41b, a name of a recording medium, for example, “SD”, and a name of a storage apparatus, for example, “MAIN BODY” in which a folder that is able to be published is stored, are displayed. When the user selects the name of the recording medium or the storage apparatus of the folder whose data is to be published among these names, in this example, when the “SD” is selected, the DLNA setting application changes the screen displayed on the first display section 23 of the mobile terminal 2 to a DLNA setting screen 41c, and the name of the recording medium or the storage apparatus selected on the DLNA setting folder setting screen 41b, in this example, the “SD” is displayed.

FIG. 7E is a view for explaining activation of the DLNA server. When the user selects the “ACTIVATION ON” shown in the item of the “ACTIVATION ON/OFF FLAG” on a DLNA setting screen 41d, the DLNA server is activated. The activated DLNA server starts to create a database (hereinafter referred to as a “DB”). At this time, the DLNA server displays a message of “PREPARING DLNA, (DB) CREATING” in the center of the screen as shown in a ULNA setting screen 41e.

The DB is a database with which information about publication files is registered, and is created to manage file names of publication files including publication data sets published by the DLNA server on the basis of the folder. Specifically, information about publication files in the folder of the recording medium or the storage apparatus with the name set to the item of the “PUBLICATION FOLDER SETTING” is registered with the DB. The DB is stored in the first temporal storage section 22 of the mobile terminal 2. Hereinafter, publication data sets stored in a publication folder is also referred to simply as a publication file. In response to a request from the DLNA client embedded in the display apparatus 3, the DLNA server creates a content list that is a list of publication file names of publication data sets that are able to be displayed by the DLNA client based on information about publication files stored in the DB, and transmits the created content list to the DLNA client. The DLNA client displays the content list on the second display section 33 and acquires a file of a file name selected by the user from the DLNA server for display. The file name is output data identification information.

When the creation of the DB is completed, the DLNA server displays a message of “DLNA IS READY.” in the center of the screen as shown in a DLNA setting screen 41f, and thereafter changes the item of the “ACTIVATION ON/OFF FLAG” displaying the “ACTIVATION ON” on the DLNA setting screen to “ACTIVATION OFF” as shown in a DLNA setting screen 41h. The “ACTIVATION OFF” shows that the item of the “ACTIVATION ON/OFF FLAG” is in the state for instructing to stop activation of the DLNA server.

FIG. 7F is a view showing a screen 42 when an image of other application program (hereinafter referred to as “other APP”) is displayed. In a case where other APP is activated and an image by other APP is displayed on the screen, when the DLNA server is in operation, an icon showing that the DLNA server is in operation, for example, an icon 421 of “DLNA IN OPERATION” is displayed on a status notification area 422 provided on the screen.

FIG. 7G is a view showing an example of a camera function screen 43. In a case where the mobile terminal 2 has a shooting apparatus such as a camera and a camera function for using the camera, for example, when the user activates the camera function of the mobile terminal 2, the camera function screen 43 is displayed so that it becomes possible to shoot a picture by the camera. The camera function is realized by an application program for shooting a picture using the shooting apparatus such as the camera, and is activated by selecting an item of the camera function from the menu displayed on the first display section 23 of the mobile terminal 2, similarly to the case when the DLNA setting application is activated. In the shooting of a picture, shooting may be performed by causing any of the operation keys provided in the operation section 29 to function as a shutter, or a dedicated operation key serving as a shutter may be provided in the operation section 29 to enable shooting by pressing the operation key.

On the camera function screen 43, a tile of “CAMERA” and an image 431 of a shot picture are displayed. When a destination of the shot picture to save is set to the SD card 4, image data of the image 431 of the shot picture is recorded in a folder of the SD card 4.

FIG. 7H is a view showing an example of a photo viewer operation screen 44. A photo viewer which is an image display section is one of functions embedded in the mobile terminal 2, and is realized by an application program for displaying image data. The photo viewer is activated by selecting an item of the photo viewer from the menu displayed on the first display section 23 of the mobile terminal 2, similarly to the case when the DLNA setting application is activated. The photo viewer is a function for displaying image data stored in the SD card 4 or the first temporal storage section 22, and is not able to display image data stored in the DB.

On the photo viewer operation screen 44, a tile of “PHOTO VIEWER”, a folder name being selected, and a list of file names in the folder are displayed in descending order of a date when image data is generated (hereinafter referred to as “date descending order”). In image data stored in the SD card 4 or the first temporal storage section 22, together with a file name of each image data, times and dates when the respective sets of image data are generated are stored, and the date descending order is the order going back, based on those times and dates, to the past time and date from the most recent time and date. For example, when image data is image data of a picture, the time and date of generation is time and date when the picture is shot, and when image data is image data of an image created by a drawing application program or the like, it is time and date of creation. The folder name is folder identification information. The date descending order is arranging order decided based on a predetermined basis.

In the example shown in FIG. 7H, the selected folder name is displayed in parentheses as “CAMERA/AAA1000”, and “DSC0100”, “DSC0099” and “DSC0098” are displayed in this order in descending order downward as file names in the folder.

FIG. 7I is a view showing an example of other photo viewer operation screen 44a. In the example shown in FIG. 7I, the selected folder name is displayed in parentheses as “PICTURE/20091224 CHRISTMAS PARTY”, and “CCC0013”, “BBB0011” and “BBB0010” are displayed in this order in descending order downward as file names in the folder.

In this manner, when image data is displayed by the photo viewer, the display is necessarily performed in the date descending order, while when displaying by the DLNA server, the display is able to be performed not only in the date descending order but also in ascending order of a date when image data is generated (hereinafter referred to as “date ascending order”) as described below. The date ascending order is the order arranging, based on those times and dates, from the oldest time and date to the most recent time and date.

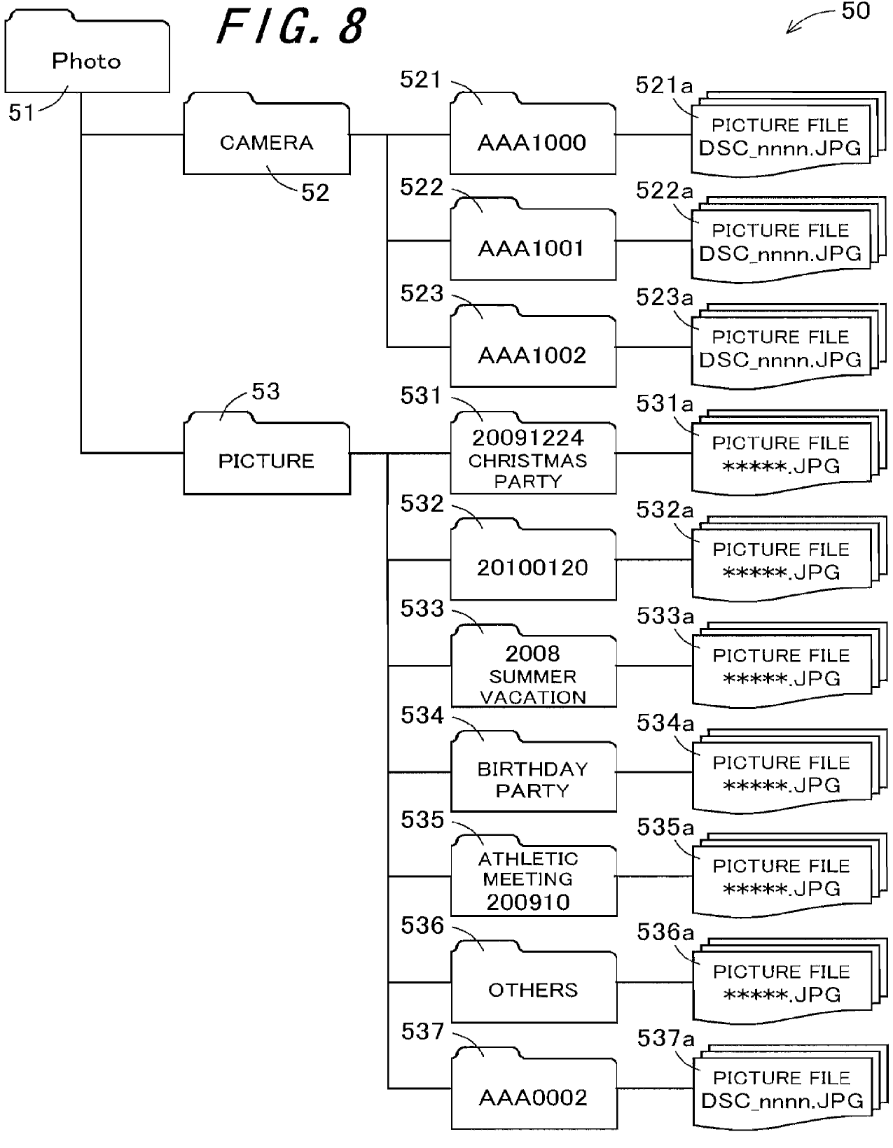

FIG. 8 is a view showing an example of a directory structure 50 of data recorded in the SD card 4. A directory structure of data stored in the first temporal storage section 22 is similar to the configuration of the directory structure 50 of data recorded in the SD card 4, and description will be given below only for the directory structure 50 of data recorded in the SD card 4 and description for the directory structure of data stored in the first temporal storage section 22 will be omitted.

A folder in a top layer is a folder 51 with a folder name of “Photo” and folders in a second layer that is a layer directly under the top layer are two folders of a folder 52 with a folder name of “CAMERA” and a folder 53 with a folder name of “PICTURE” included in the folder 51 with the file name of “Photo”.

Folders in a third layer that is a layer directly under the second layer are three folders of a folder 521 with a folder name of “AAA1000”, a folder 522 with a folder name of “AAA1001” and a folder 523 with a folder name of “AAA1002” included in the folder 52 with the file name of “CAMERA”. Further, in the third layer, there are seven folders of a folder 531 with a folder name of “20091224 CHRISTMAS PARTY”, a folder 532 with a folder name of “20100120”, a folder 533 with a folder name of “2008 SUMMER VACATION”, a folder 534 with a folder name of “BIRTHDAY PARTY”, a folder 535 with a folder name of “ATHLETIC MEETING 200910”, a folder 536 with a folder name of “OTHERS”, and a folder 537 with a folder name of “AAA0002” included in the folder 53 with the folder name of “PICTURE”.

In each folder of the folders 521 to 523 and the folders 531 to 537 in the third layer, picture files 521a to 523a and picture files 531a to 537a are recorded, respectively. For example, a plurality of picture files 521a each with a file name of “DSC_nnnn.JPG” are stored in the folder 521, and a plurality of picture files 531a each with a file name of “*****.JPG” are stored in the folder 531. The “nnnn” is the number in the ascending order applied in shooting order and the same is also applicable to the “*****”. Each image data is stored in each file in this ascending order.

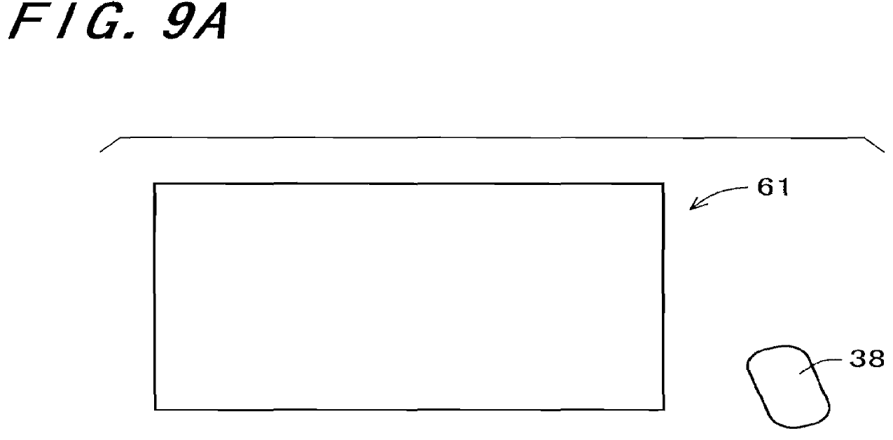

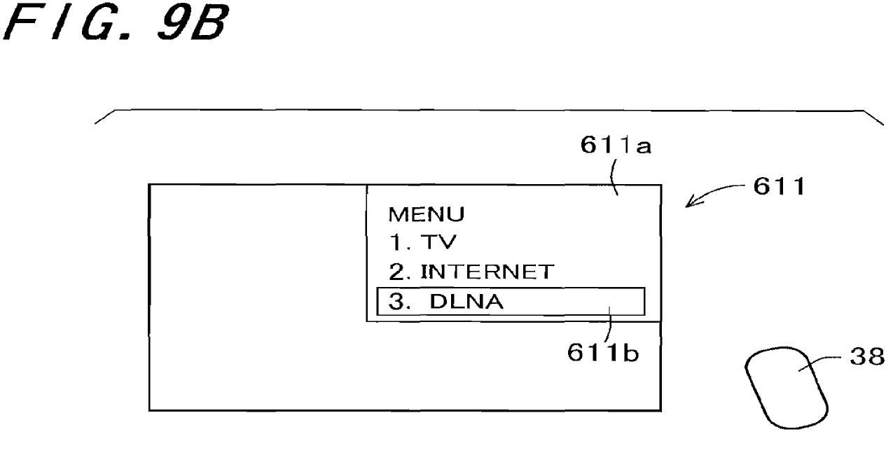

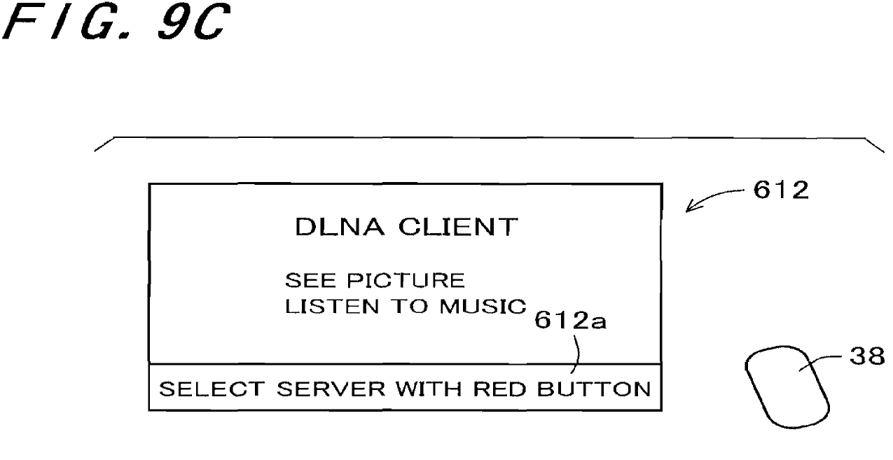

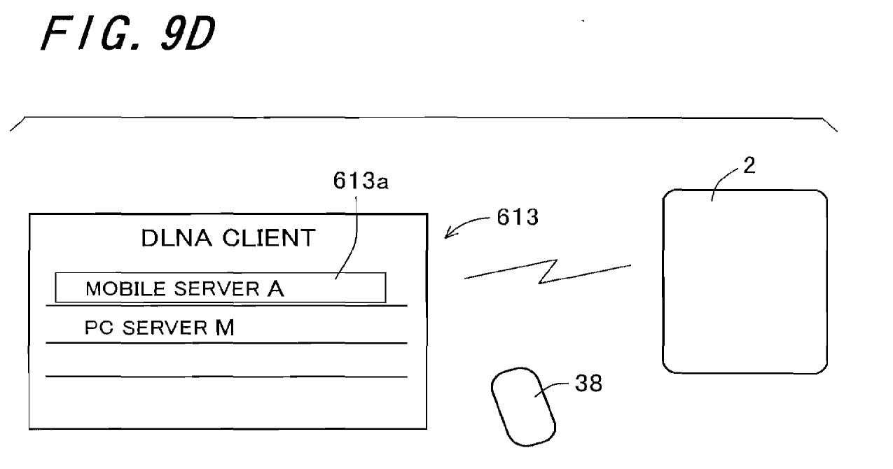

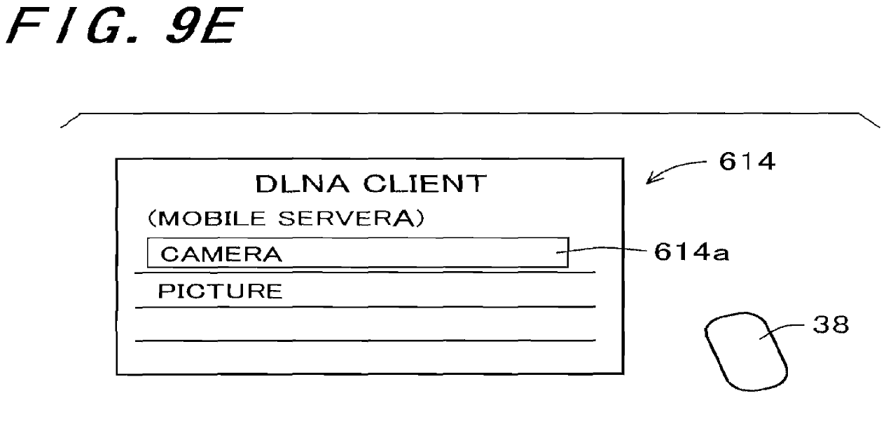

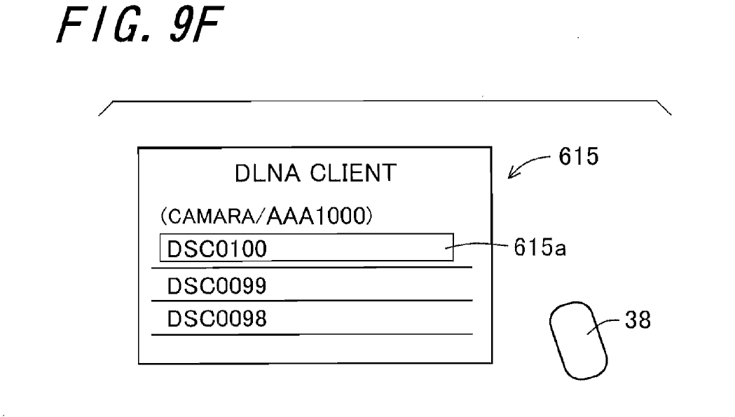

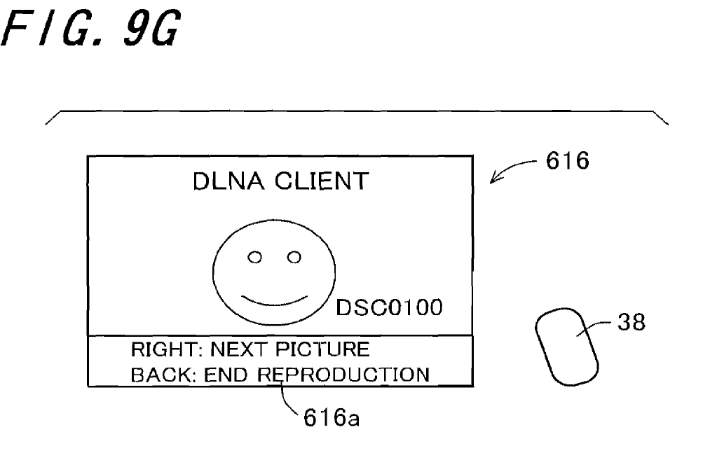

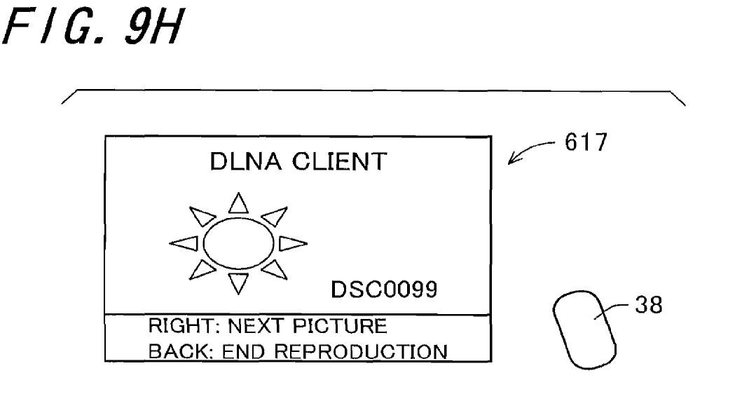

FIGS. 9A to 9H are views showing a first example of operation procedure for displaying a picture by the display apparatus 3. FIG. 9A is a view for explaining an operation for displaying a menu. When the user operates the menu key of the remote controller 38 in a state where a video of television broadcasting is displayed on a screen 61 of the display apparatus 3, the menu is able to be displayed.

FIG. 9B is a view showing an example of a screen 611 on which a menu 611a is displayed. In the menu 611a, three items of, for example, “1. TV”, “2. INTERNET” and “3. DLNA” are displayed. The “TV” is an abbreviation for “television”. When desiring to activate the DLNA client, the user operates the cursor key of the remote controller 38 and points a cursor 611b to the item of the “3. DLNA” of the menu 611a to operate the enter key, so that it is possible to activate the DLNA client and to display a top screen of the DLNA client. When the item of the “1. TV” is selected, a screen for receiving television broadcasting is given, and when the item of the “2. INTERNET” is selected, a screen for operating the Internet is given.

The DLNA client is a function embedded in the display apparatus 3 and is a function realized when the second CPU 20 executes a program stored in the second temporal storage section 32. The DLNA client performs processing such as display of an image or playing of music in cooperation with the DLNA server of the mobile terminal 2. The DLNA client is realized by an application program executed by the second CPU 30 of the display apparatus 3.

FIG. 9C is a view showing a top screen 612 of a DLNA client. On the top screen 612, a tile of “DLNA CLIENT”, selection items comprised of items of “SEE PICTURE”, “LISTEN TO MUSIC” and the like, as well as an item 612a of “SELECT SERVER WITH RED BUTTON” are displayed. By selecting any of the selection items and operating a red button (not shown) of the remote controller 38, the user is able to display a server selection screen corresponding to the selected item. That is, when the “SEE PICTURE” is selected among the selection items and the red button is operated, a server selection screen 613 for selecting a DLNA server that performs display of a picture is displayed, and when the “LISTEN TO MUSIC” is selected among the selection items and the red button is operated, a server selection screen (not shown) for selecting a DLNA server that performs playing of music is displayed.

FIG. 9D is a view showing an example of the server selection screen 613. The server selection screen 613 is a screen for selecting a DLNA server, on which a server list showing a list of selectable servers is displayed. The server selection screen 613 shown in FIG. 9D is the server selection screen 613 when the “SEE PICTURE” is selected on the top screen 612, and on the server selection screen 613 shown in FIG. 9D, two DLNA servers of “MOBILE SERVER A” and “PC SERVER M” are displayed. The “PC” is an abbreviation for a personal computer. The mobile server A is a server name applied to the DLNA server of the mobile terminal 2, and the “PC SERVER M” is a server name applied to the DLNA server embedded in a PC connected to the same network to which the display apparatus 3 is connected.

When the user operates the remote controller 38 to select the “MOBILE SERVER A”, the DLNA client starts communication with the DLNA server embedded in the mobile terminal 2 to cooperate with the DLNA server to which the name of the “MOBILE SERVER A” is applied.

FIG. 9E is a view showing an example of a top directory screen 614. On the top directory screen 614, a top directory of a folder of a recording medium or a storage apparatus with a name set to the item of the “PUBLICATION FOLDER SETTING” of the selected DLNA server is displayed. On the top directory screen 614, a DLNA server name being selected, for example, the “MOBILE SERVER A” is displayed in parentheses, and under which, folder names of folders in the top directory, for example, a folder name of “CAMERA” and a folder name of “PICTURE” are displayed.

FIG. 9F is a view showing an example of a picture list display screen 615. When the user sequentially selects a directory in a lower directory from the top directory displayed in FIG. 9E to select a folder having image data of a picture that is desired to be displayed, the picture list display screen 615 for the folder is displayed. On the picture list display screen 615, the selected folder name is displayed in parentheses, and under which, file names in which image data of pictures that are able to be displayed are stored are displayed in publishing order, which will be described below, registered with the DE.

For example, when a folder name of “CAMERA” is selected in the top directory and a folder name of “AAA1000” is selected under that layer, the picture list display screen 615 shown in FIG. 9F is displayed. On the picture list display screen 615 shown in FIG. 9F, the selected folder name of “CAMERA/AAA1000” is displayed in parentheses, and as file names of image data that are able to be displayed, a file name of “DSC0100”, a file name of “DSC0099” and a file name of “DSC0098” are displayed in the date descending order downward.

A picture list is a content list for image data of pictures among content lists created by the DLNA server. Content lists that are output data lists include, in addition to the picture list, a music list that is a content list for sound data of music, a moving image list that is a content list for moving image data of a moving image content, and the like. A content list is generated on the basis of a folder including data such as image data, and is a list in which file names in the folder are indicated as a list in the order of display or reproduction. When the “LISTEN TO MUSIC” is selected on the top screen 612 of FIG. 9C, a music list display screen (not shown) for displaying a music list is displayed instead of the picture list display screen 615.

FIG. 9G is a view showing an example of a picture display screen 616. When the user selects a file name having image data that is desired to be displayed from the picture list displayed in FIG. 9F, for example, “DSC0100”, image data of the selected file name is displayed on the picture display screen 616. On the picture display screen 616, an image by the image data of the selected file name is displayed, and a file name of the image data is displayed in the image. In addition, an operation explanation message 616a for explaining an operation method that displays “RIGHT: NEXT PICTURE BACK: END REPRODUCTION” is also displayed in the last line.

The operation explanation message 616a displaying “RIGHT: NEXT PICTURE BACK: END REPRODUCTION” shows that when a right-direction cursor key is operated among cursor keys of the remote controller 38, a next picture shown in the picture list is displayed. It is then shown that when the back key is operated among cursor keys of the remote controller 38, reproduction of the picture, that is, display of the picture is ended to go back to the picture list display screen 615. On the picture display screen 616 shown in FIG. 9G, image data of a file name of “DSC0100” is displayed.

When no operation has been performed by the remote controller 38 and predetermined time has elapsed after the picture display screen 616 was displayed, a slide show function is operated so that the DLNA client displays image data of file names of the picture list shown on the picture list display screen 615 sequentially in the order of the picture list for each given time.

FIG. 9H is a view showing an example of other picture display screen 617. The picture display screen 617 is a screen displayed when a right cursor key of the remote controller 38 is operated on the picture display screen 616 shown in FIG. 9G, on which image data of a file name of “DSC0099” next to the file name of “DSC0100” in the picture list of the picture list display screen 615 shown in FIG. 9F is displayed. Since the picture list has the date descending order, the image data of the file name of “DSC0099” previous to the image data of the file name of “DSC0100” is displayed, and the image data is sequentially displayed in the reverse chronological order.

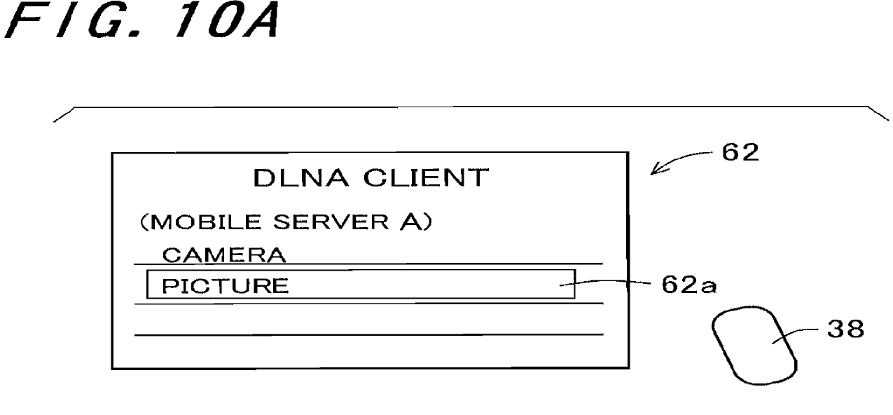

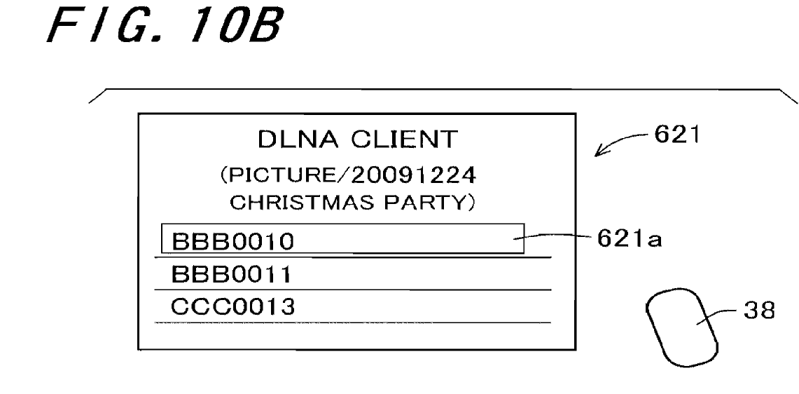

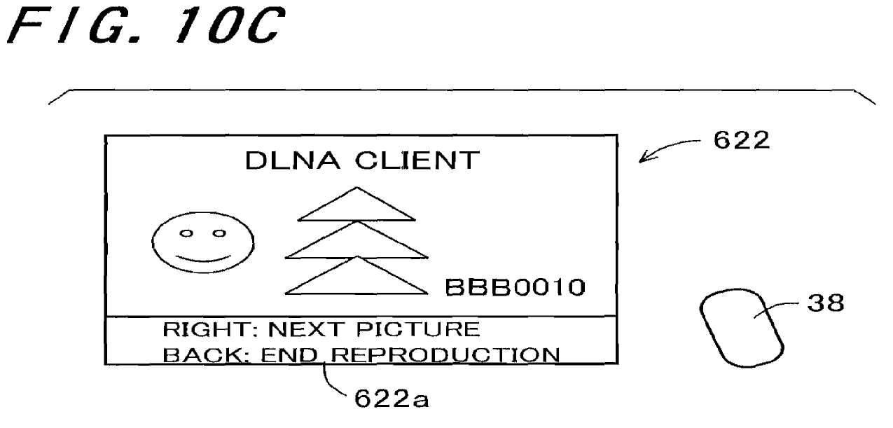

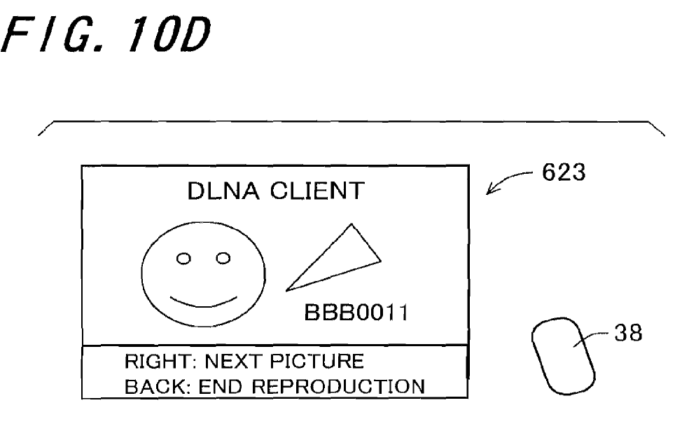

FIGS. 10A to 10D are views showing a second example of operation procedure for displaying a picture by the display apparatus 3. Though image data is displayed in the date descending order in the first example shown in FIGS. 9A to 9H, the second example is an example in which image data is displayed in the date ascending order.

FIG. 10A shows a top directory screen 62 on which a top directory of a folder displayed by the mobile server A is displayed, which is the same screen as the top directory screen 614 shown in FIG. 9E. On the top directory screen 62 shown in FIG. 10A, a cursor 62a is moved to a folder name of “PICTURE” by the remote controller 38. When the folder name of “PICTURE” is selected and a folder name of “20091224 CHRISTMAS PARTY” is selected from folder names displayed subsequently by the remote controller 38, it is possible to display a picture list display screen 621 for the folder name of “20091224 CHRISTMAS PARTY”.

FIG. 10B is a view showing an example of the picture list display screen 621. On the picture list display screen 621, file names of files included in the folder with the folder name of “20091224 CHRISTMAS PARTY” are displayed in publishing order, which will be described below, registered with the DB, in this case, in the date ascending order. On the picture list display screen 621 shown in FIG. 10B, the selected folder name of “PICTURE/20091224 CHRISTMAS PARTY” is displayed in parentheses, and as file names of image data that are able to be displayed, a file name of “BBB0010”, a file name of “BBB0011” and a file name of “CCC0013” are displayed in the date ascending order downward.

By selecting a file name of image data that is desired to be displayed from the picture list displayed on the picture list display screen 621 by the remote controller 38, the user is able to display the image data of the selected file name. For example, when the file name of “BBB0010” is selected by the cursor 621a, it is possible to display image data of the file name of “BBB0010”.

FIG. 10C is a view showing an example of still other picture display screen 622. On the picture display screen 622, image data of the file name of “BBB0010” is displayed, and an operation explanation message 622a displaying “RIGHT: NEXT PICTURE BACK: END REPRODUCTION” is also displayed.

FIG. 10D is a view showing an example of still other picture display screen 623. On the picture display screen 623, image data of the file name of “BBB0011”, which is a screen displayed when the right cursor key of the remote controller 38 is operated on the picture display screen 622 shown in FIG. 10C is displayed. That is, the image data of the file name of “BBB0011” next to the file name of “BBB0010” in the picture list of the picture list display screen 621 shown in FIG. 10B is displayed.

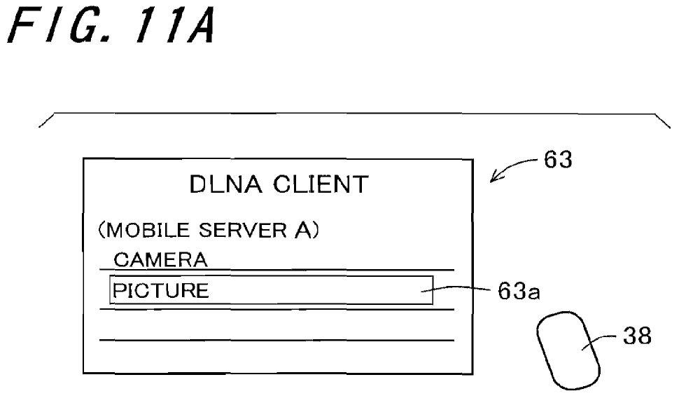

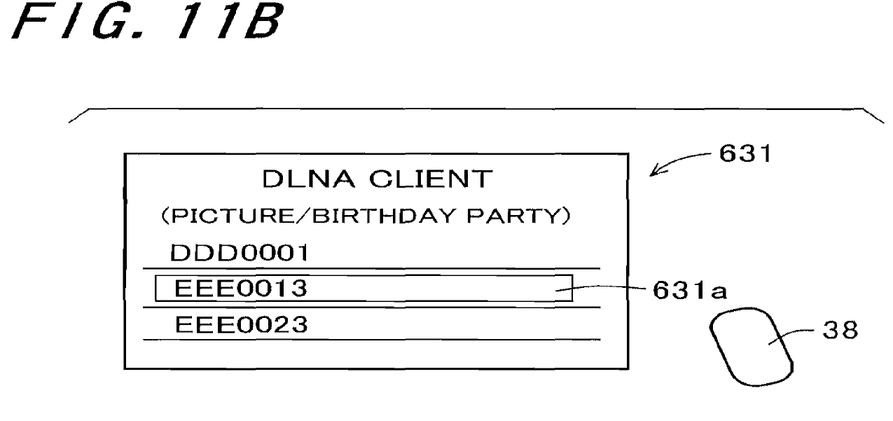

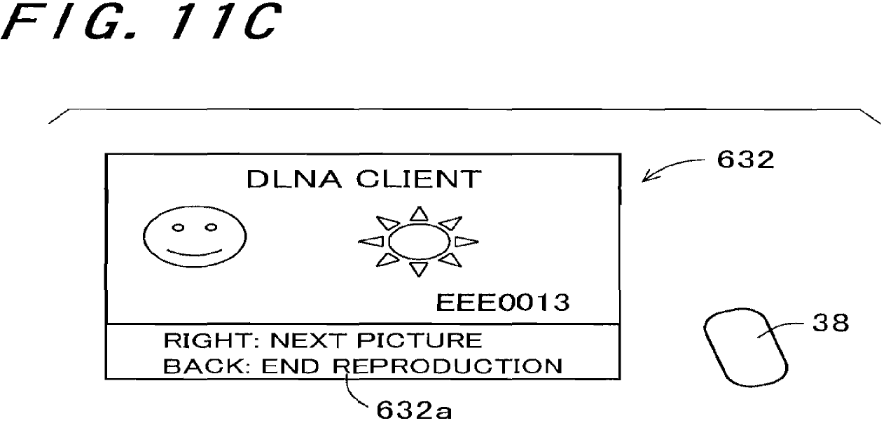

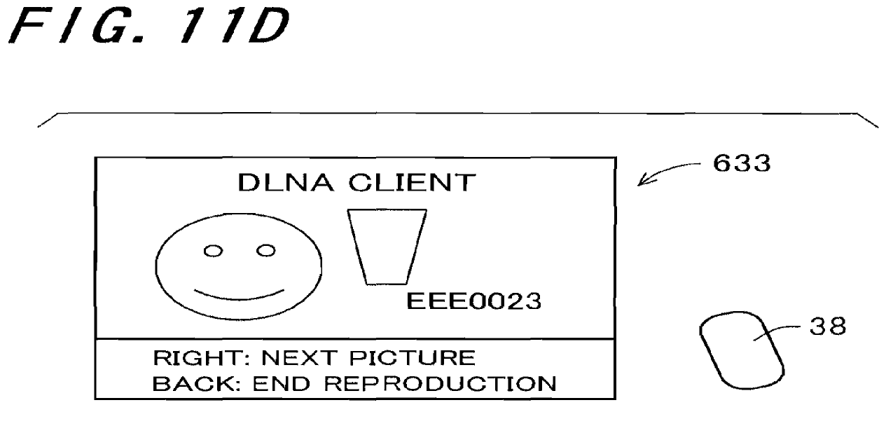

FIGS. 11A to 11D are views showing a third example of processing procedure for displaying a picture by the display apparatus 3. The third example is an example in which image data is displayed in the date ascending order, similarly to the second example. FIG. 11A shows a top directory screen 63 on which a top directory of a folder displayed by the mobile server A is displayed, which is the same screen as the top directory screen 62 shown in FIG. 10A. Also on the top directory screen 63 shown in FIG. 11A, a cursor 63a is moved to a folder name of “PICTURE” by the remote controller 38. When the folder name of “PICTURE” is selected and a folder name of “BIRTHDAY PARTY” is selected from folder names displayed subsequently by the remote controller 38, it is possible to display a picture list display screen 631 of the folder name of “BIRTHDAY PARTY”.

FIG. 11B is a view showing an example of the picture list display screen 631. On the picture list display screen 631, file names of files included in the folder with the folder name of “BIRTHDAY PARTY” are displayed in publishing order, which will be described below, registered with the DB, in this case, in the date ascending order. On the picture list display screen 631 shown in FIG. 11B, the selected folder name of “PICTURE/BIRTHDAY PARTY” is displayed in parentheses, and as file names of image data that are able to be displayed, a file name of “DDD0001”, a file name of “EEE0013” and a file name of “EEE0023” are displayed in the date ascending order downward.

By selecting a file name of image data that is desired to be displayed from the picture list displayed on the picture list display screen 631 by the remote controller 38, the user is able to display the image data of the selected file name. For example, when the file name of “EEE0013” is selected by the cursor 631a, it is possible to display image data of the file name of “EEE0013”.

FIG. 11C is a view showing an example of still other picture display screen 632. On the picture display screen 632, image data of the file name “EEE0013” is displayed, and an operation explanation message 632a displaying “RIGHT: NEXT PICTURE BACK: END REPRODUCTION” is also displayed.

FIG. 11D is a view showing an example of still other picture display screen 633. On the picture display screen 633, image data of the file name of “EEE0023”, which is a screen displayed when the right cursor key of the remote controller 38 is operated on the picture display screen 632 shown in FIG. 11C is displayed. That is, image data of the file name of “EEE0023” next to the file name of “EEE0013” in the picture list of the picture list display screen 621 shown in FIG. 11B is displayed.

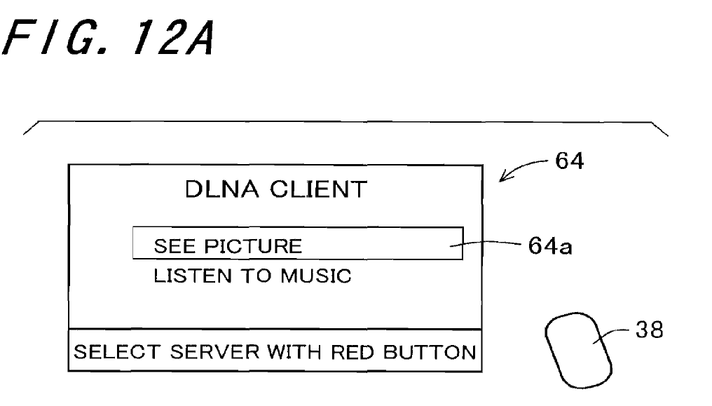

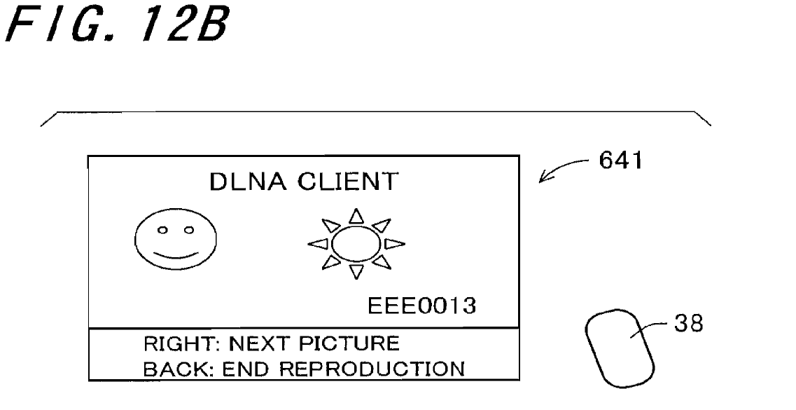

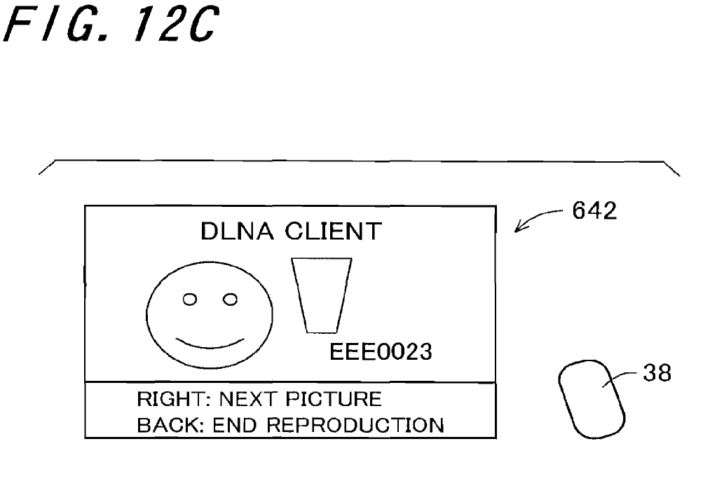

FIGS. 12A to 12C are views showing a fourth example of operation procedure for displaying a picture by the display apparatus 3. The fourth example is an example when display of image data included in a folder that includes image data displayed last time before is restarted or playing of music data included in a folder that includes music data played last time before is restarted.

FIG. 12A is a view showing an example of other top screen 64. The top screen 64 is the same screen as the top screen 612 shown in FIG. 9C. After the top screen 64 is displayed, without operating a red button (not shown) of the remote controller 38, by selecting the “SEE PICTURE” with a cursor 64a, the user is able to restart display of image data included in a folder that includes image data displayed last time before, or by selecting the “LISTEN TO MUSIC” with the cursor 64a, to restart playing of music data included in a folder that includes music data played last time before.

The DLNA client stores a folder name of image data displayed last time before, a picture list of the folder, and a file name of image data displayed first time among image data in the folder in the second temporal storage section 32. Then, after displaying the top screen 64, when the “SEE PICTURE” is selected with the cursor 64a without operating the red button (not shown) of the remote controller 38, display of image data is restarted from the image data of the file name stored in the second temporal storage section 32 based on the folder name and the picture list stored in the second temporal storage section 32.

When displaying from a sequel to the image data displayed last time, instead of a file name of image data displayed first time, a file name of the image data displayed last time is stored, and when display of image data is restarted, display is restarted from image data of a file name next to the folder name stored in the second temporal storage section 32. When the next image data is last image data in the folder including the image data, display is restarted from first image data in the same folder.

FIG. 12B is a view showing an example of still other picture display screen 641. The picture display screen 641 is a picture display screen just after display of an image is restarted, and is the same screen as the picture display screen 632 shown in FIG. 11C. FIG. 12C is a view showing an example of still other picture display screen 642. The picture display screen 642 is a picture display screen that is displayed next to the picture display screen 641 shown in FIG. 12B, and is the same screen as the picture display screen 633 shown in FIG. 11D.

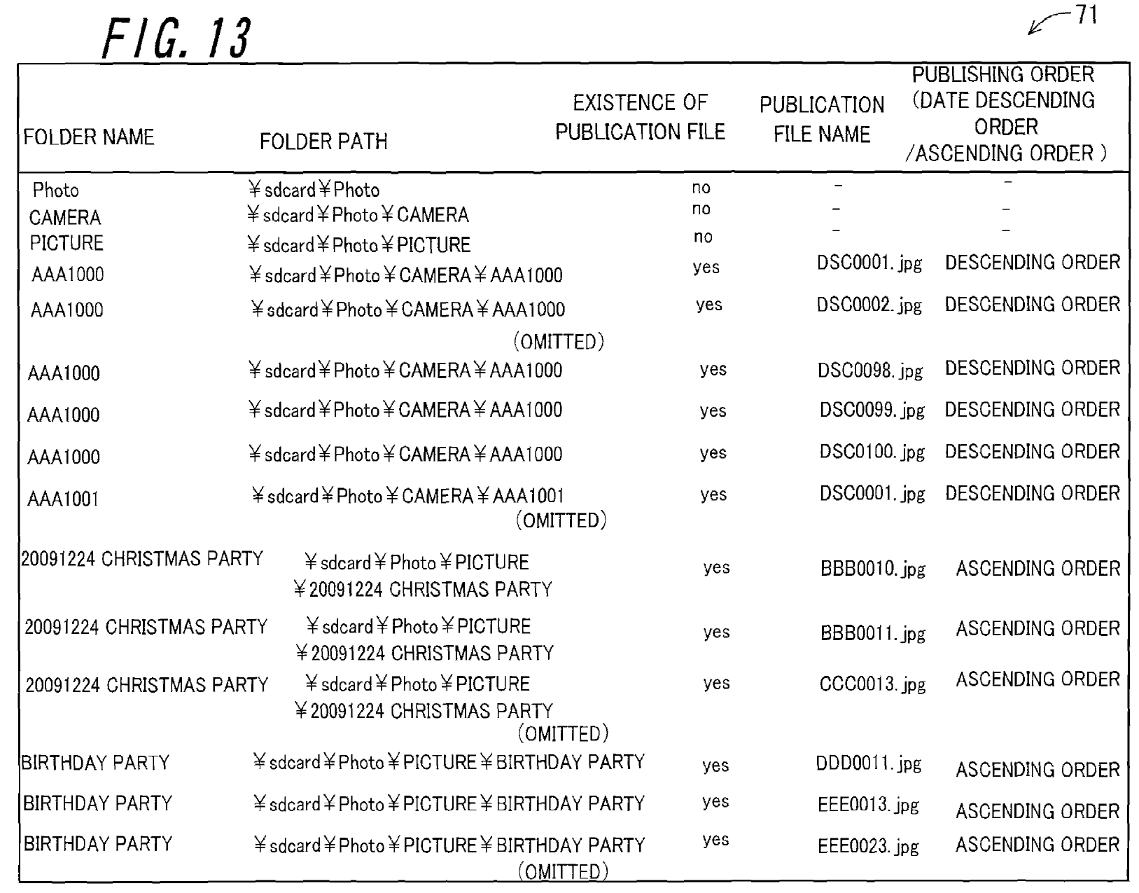

FIG. 13 is a view showing a DB data structure 71. The DB is generated by the DLNA server of the mobile terminal 2, that is, the mobile server A, and is stored in the first temporal storage section 22 of the mobile terminal 2. Just after being activated, the DLNA server creates the DB for publication data sets recorded in a recording medium, for example, the SD, or stored in a storage apparatus, for example, a main body, having a name set to the item of the “PUBLICATION FOLDER SETTING” of DLNA setting.

The DB data structure 71 includes five items of “FOLDER NAME”, “FOLDER PATH”, “EXISTENCE OF PUBLICATION FILE”, “PUBLICATION FILE NAME” and “PUBLISHING ORDER”. The item of the “FOLDER NAME” includes a folder name of a folder recorded in a recording medium, for example, an SD, or stored in a storage apparatus, for example, a main body, having a name set to the item of the “PUBLICATION FOLDER SETTING”. The SD is, for example, the SD card 4, and the main body is, for example, the first temporal storage section 22 of the mobile terminal 2. The item of the “FOLDER PATH” shows a path in a directory in which a folder whose folder name is shown in the item of the folder name is. The item of the “EXISTENCE OF PUBLICATION FILE” shows whether or not a file exists in a folder whose folder name is shown in the item of the “FOLDER NAME”, in which “no” shows that no file to be published exists in the folder and “yes” shows that a file to be published exists in the folder.

The item of the “PUBLICATION FILE NAME” shows file names of files included in a folder whose folder name is shown in the item of the “FOLDER NAME” one by one with respect to the folder whose item of the “EXISTENCE OF PUBLICATION FILE” has “yes”. For the folder whose item of the “EXISTENCE OF PUBLICATION FILE” has “no”, no publication file name is registered and “-” showing that no publication file is recorded or stored in the folder is registered. The file name registered in the item of the “PUBLICATION FILE NAME” is registered in recording order in the SD or in storing order in the main body. In the SD or the main body, each file is stored in the order of generation, and file names registered in the publication file names of the DE are also stored in the order of generation, that is, the date ascending order.

Though registration is performed in recording order in the SD or storing order in the main body for the DB data structure 71 shown in FIG. 13, registration may be performed in the order shown in the item of the “PUBLISHING ORDER” at the time of registration in the DB. Since in files of data recorded in the SD card 4 and data stored in the first temporal storage section 22, time and date information indicating times and dates when the respective sets of data are generated is also recorded or stored, the registration is performed in the date descending order or the date ascending order based on the time and date information.

The item of the “PUBLISHING ORDER” shows the order of publishing files whose file names are shown in the item of the “PUBLICATION FILE NAME” with respect to the folder whose item of the “EXISTENCE OF PUBLICATION FILE” has “yes”. With respect to the folder whose item of the “EXISTENCE OF PUBLICATION FILE” has “no”, no publishing order is registered and “-” showing having no publishing order is registered. The publishing order that is arranging order has the date descending order and the date ascending order, and any of the publishing order is shown. The “DESCENDING ORDER” shows that the publishing order is the date descending order and the “ASCENDING ORDER” shows that the publishing order is the date ascending order. When the DLNA server creates the DB, the date descending order or the date ascending order is determined for the publishing order based on a folder name of a folder including each file and registered in the DB. The same publishing order is registered to files in the same folder.

Specifically, when a folder name includes “date” or “event name”, the publishing order is registered as the date ascending order, and when a folder name does not include any of the “date” and the “event name”, the publishing order is registered as the date descending order. In a case where image data in the folder whose folder name includes “date” or “event name” is, for example, image data of pictures, when being displayed in the shooting order, it is possible to display images of the pictures without failing the story line of the plurality of pictures, thus making it possible to perform the display for a viewer more effectively. The “date” is date information and the “event name” is event name information.

The “date” includes a year-month-day, a month-day, a year-month, a year and a day. The “date” may be expressed in only numbers, a combination of numbers and Chinese characters, a combination of numbers and Roman characters, or the like. When the “date” is expressed in only numbers, the order of description of a year-month-day is such that when a year is expressed in “YYYY” or “YY”, a month is expressed in “MM” and a day is expressed in “DD”, for example, it is possible to describe in the order such as “YYYYMMDD”, “YYMMDD”, “MMDDYYYY”, “MMDDYY” and “MMDD”. When the “date” is expressed in the combination of numbers and Chinese characters, for example, expression is given in “2009 [symbol] 12 [symbol] 24 [symbol] ”, “2009 [symbol] 10 [symbol] ”, “2008 [symbol] ” and the like. When the “date” is expressed in the combination of numbers and Roman characters, for example, a month may be expressed in full spelling or an abbreviation of English, so that a year, a month and a day are separated by a code such as “_”, “.” or “(space)”. Specifically, display is performed in “Jan. 12, 2010”, “January 12”, “2010 Jan. 12” and the like. As to Roman characters, mixture of capital letters and small letters and mixture of two-byte character and one-byte character may be allowed.

The “event name” may be a name related to events, for example, such as “New Year”, “New Year's visit to shrine”, “Birthday Party”, “Class Reunion”, “Year-End Party”, “Farewell Party”, “Welcome Party”, “Going-Away Party”, “Seven-Five-Three Festival”, “Christmas”, “Festival”, “Recital”, “School Festival”, “Sports Day”, “Athletic Meeting”, “Excursion”, “Trip” and “Place Name”.

When a folder name includes a control keyword that is a keyword for control (hereinafter also referred to simply as a “keyword”), the predetermined publishing order may be set for each control keyword. When the control keyword is used, the control keyword is given priority over the “date” and the “event name”. That is, in a case where a folder name includes a control keyword, even when the folder name includes the “date” or the “event name”, judgment of the publishing order by the “date” or the “event name” included in the folder name is not performed. In a case where one folder name includes a plurality of control keywords, the control keywords are invalidated and judgment of the publishing order by the control keywords is not performed. Information indicating a keyword is keyword information.

Examples of the control keyword include “Reverse”, “Rewind”, “ABC”, “Randam”, “Favorite” and the like. In the “Reverse”, the publishing order is registered as “date descending order” or “reverse order of standard setting”. The “standard setting” is the “date descending order” or the “date ascending order”, and is stored in advance in the first temporal storage section 22. When the “standard setting” is set to the “date descending order”, the “reverse order of standard setting” is the “date ascending order”, and when the “standard setting” is set to the “date ascending order”, the “reverse order of standard setting” is the “date descending order”. In the “Rewind”, the publishing order is registered as the “date descending order” or the “reverse order of standard setting”.

In the “ABC”, the publishing order is registered as “ABC order”. The “ABC order” refers to the alphabetical order, and at the time of creating a content list, when the publishing order is set to the “ABC order”, with respect to files included in a folder with the selected folder name, the DLNA server arranges file names in the alphabetical order based on a character string comprised of Roman characters included in file names, and when numbers are also included, performs the arrangement based on the character string comprised of Roman characters in the alphabetical order and then arranges the numbers in the same character string in the ascending order.

In the “Randam”, the publishing order is registered as “at-random order”. The “at-random order” refers to ruleless order, and at the time of creating a content list, when the publishing order is set to the “at-random order”, for example, the DLNA server generates random numbers, for example, by using a function for generating random numbers, and arranges file names of files included in a folder with the selected folder name in the ruleless order using the generated random numbers.

In the “Favorite”, for example, the publishing order is registered as “descending order of the number of reproductions”. In this case, the DLNA server regards the number of times that a file is displayed or reproduced as the number of reproductions to store for each file name in the first temporal storage section 22, and at the time of creating a content list, when the publishing order is set to the “descending order of the number of reproductions”, arranges file names of files included in the folder with the selected folder name in the descending order of the number of reproductions based on the number of reproductions stored in the first temporal storage section 22.

The control keyword is not limited thereto and other control keyword may be used. In addition, it may be configured such that, for example, the user is able to set a control keyword and the publishing order for the control keyword to the first temporal storage section 22 by the operation section 29, and the DLNA server registers the publishing order in the DB in accordance with the control keyword and the publishing order set to the first temporal storage section 22.

The DB data structure 71 shown in FIG. 13 has the item of the “PUBLICATION FOLDER SETTING” set to the “SD”, and is a data structure when the directory structure of the SD card 4 is the directory structure 50 shown in FIG. 8. In the top line of the data structure 71, a folder name of “Photo” of a folder that is in a top layer of the directory structure 50 is shown in the item of the “FOLDER NAME”, “¥sdcard¥Photo” is shown in the item of the “FOLDER PATH”, and “no” is shown in the item of the “EXISTENCE OF PUBLICATION FILE”. The “¥sdcard” shown in the item of the “FOLDER PATH” indicates a route directory of the SD card 4. In the item of the “PUBLICATION FILE NAME” and the item of the “PUBLISHING ORDER”, “-” is shown.

In the second line of the data structure 71, a folder name of “CAMERA” of a folder that is in the second layer of the directory structure 50 is shown in the item of the “FOLDER NAME”, “¥sdcard¥Photo¥CAMERA” is shown in the item of the “FOLDER PATH”, “no” is shown in the item of the “EXISTENCE OF PUBLICATION FILE”, and “-” is shown in the item of the “PUBLICATION FILE NAME” and the item of the “PUBLISHING ORDER”. Similarly, in the third line of the data structure 71, a folder name of “PICTURE” of a folder that is in the second layer of the directory structure 50 is shown in the item of the “FOLDER NAME”, “¥sdcard¥Photo¥PICTURE” is shown in the item of the “FOLDER PATH”, “no” is shown in the item of the “EXISTENCE OF PUBLICATION FILE”, and “-” is shown in the item of the “PUBLICATION FILE NAME” and the item of the “PUBLISHING ORDER”.

In the fourth line of the data structure 71, a folder name of “AAA1000” of a folder that is in the third layer of the directory structure 50 is shown in the item of the “folder name”, “¥sdcard¥Photo¥CAMERA¥AAA1000” is shown in the item of the “FOLDER PATH”, “yes” is shown in the item of the “EXISTENCE OF PUBLICATION FILE”, “DSC0001.jpg” is shown in the item of the “PUBLICATION FILE NAME”, and “DESCENDING ORDER” is shown in the item of the “PUBLISHING ORDER”. In the lines subsequent to the fifth line of the data structure 71, with respect to files included in the folder with the same folder name of “AAA1000”, a file name of “DSC0002.jpg” to a file name of “DSC0100.jpg” are shown in the item of the “PUBLICATION FILE NAME”, and in each of which, the “DESCENDING ORDER” is shown in the item of the “PUBLISHING ORDER”.

Though in the DB data structure 71 shown in FIG. 13, the registration is performed in recording order in the SD or storing order in the main body, when the registration is performed in the order shown in the item of the “PUBLISHING ORDER”, files in the folder with a file name of “AAA0100” have the date descending order as the item of the “PUBLISHING ORDER” and are therefore registered in the order of file names of “DSC0100.jpg” to “DSC0001.jpg”.

In addition, as to files in a folder whose item of the folder name is “20091224 CHRISTMAS PARTY”, “¥sdcard¥Photo¥PICTURE¥20091224 CHRISTMAS PARTY” is shown in the item of the “FOLDER PATH”, “yes” is shown in the item of “EXISTENCE OF PUBLICATION FILE”, a file name of “BBB0010.jpg”, a file name of “BBB0011.jpg” and a file name of “CCC0013.jpg” are shown in the item of the “PUBLICATION FILE NAME” in this order, and in each of which, the “ASCENDING ORDER” is shown in the item of the “PUBLISHING ORDER”. Further, as to files in a folder whose item of the folder name is “BIRTHDAY PARTY”, “¥sdcard¥Photo¥PICTURE¥BIRTHDAY PARTY” is shown in the item of the “FOLDER PATH”, “yes” is shown in the item of “EXISTENCE OF PUBLICATION FILE”, a file name of “DDD0011.jpg”, a file name of “EEE0013.jpg” and a file name of “EEE0023.jpg” are shown in the item of the “PUBLICATION FILE NAME” in this order, and in each of which, the “ASCENDING ORDER” is shown in the item of the “PUBLISHING ORDER”.

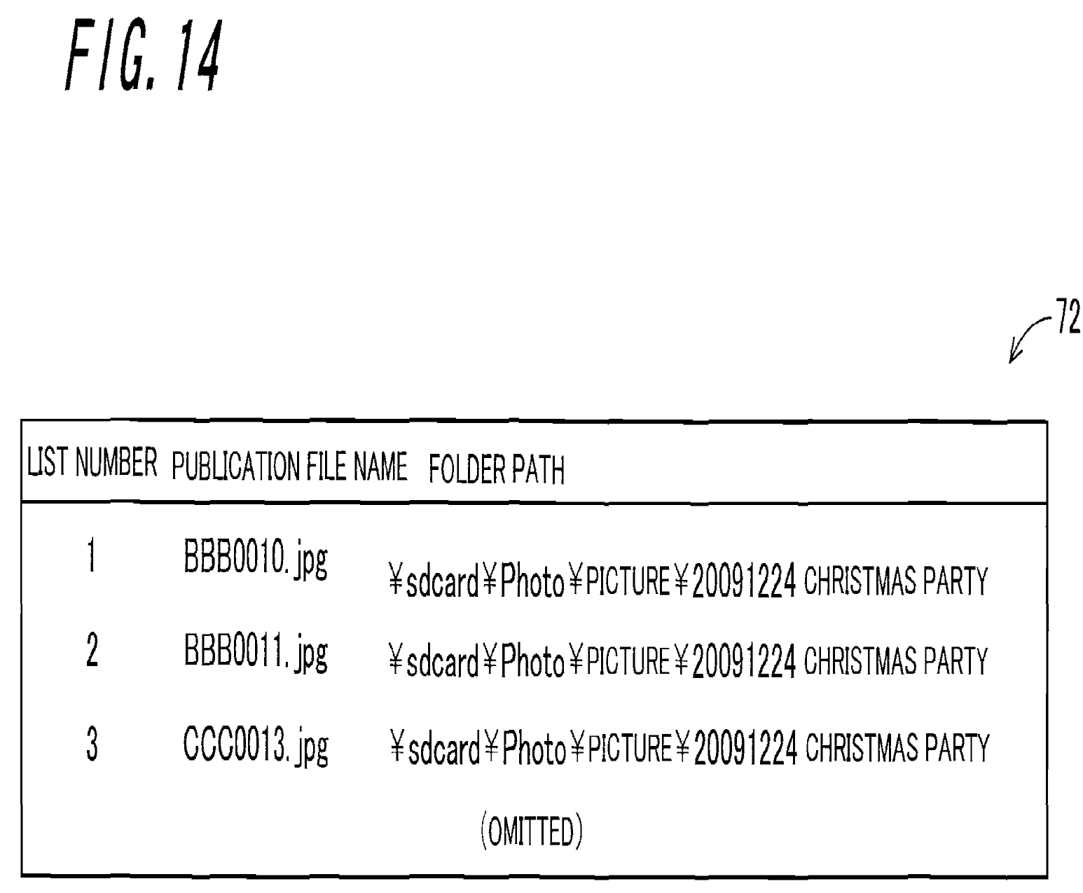

FIG. 14 is a view showing a data structure 72 of a content list. When a folder name including data to be published is informed from the DLNA client of the display apparatus 3, the content list is generated by the DLNA server of the mobile terminal 2, that is, the mobile server A based on the DB, transmitted to the DLNA client, and displayed on the display apparatus 3 by the DLNA client.

The data structure 72 of a content list includes three items of “LIST NUMBER”, “PUBLICATION FILE NAME” and “FOLDER PATH”. The item of the “LIST NUMBER” is a number showing publishing order, and an integer number is added to a file registered in the item of the “PUBLICATION FILE NAME” of the content list from “1” in the ascending order. The item of the “FOLDER PATH” shows a path of an SD or a main body in which a folder including a file with a file name shown in the item of the “PUBLICATION FILE NAME” is recorded or stored.

In the item of the “PUBLICATION FILE NAME”, a file name of a file included in the selected folder name informed from the DLNA client among the folder names registered in the item of the “FOLDER NAME” of the DB is registered one by one. The order that file names are registered in the item of the “PUBLICATION FILE NAME” is publishing order shown in the item of the “PUBLISHING ORDER” of the DB, and, for example, when the publishing order shown in the item of the “PUBLISHING ORDER” is the date descending order, registration is performed in the reverse order of the order registered in the item of the “PUBLICATION FILE NAME” of the DB, and when the publishing order shown in the item of the “PUBLISHING ORDER” is the date ascending order, registration is performed in the order registered in the item of the “PUBLICATION FILE NAME” of the DB.

The date ascending order or the date descending order may be determined depending not on the order registered in the item of the “PUBLICATION FILE NAME” of the DB but on the order registered based on time and date information indicating times and dates of generation that is recorded or stored in the SD card 4 or the first temporal storage section 22 together with image data.

In the data structure 72 of a content list shown in FIG. 14, for folders included in the folder name of “20091224 CHRISTMAS PARTY” in the path of “¥sdcard¥Photo¥PICTURE¥20091224 CHRISTMAS PARTY” shown in the item of the “FOLDER PATH”, a publication file name of “BBB0010.jpg” is shown in the list number “1”, a publication file name of “BBB0011.jpg” is shown in the list number “2” and a publication file name of “CCC0013.jpg” is shown in the list number “3”. Accordingly, in the content list shown in FIG. 14, in the order of the file of the file name of “BBB0010.jpg”, the file of the file name of “BBB0011.jpg” and the file name of “CCC0013.jpg”, image data of these files are to be displayed on the display apparatus 3.

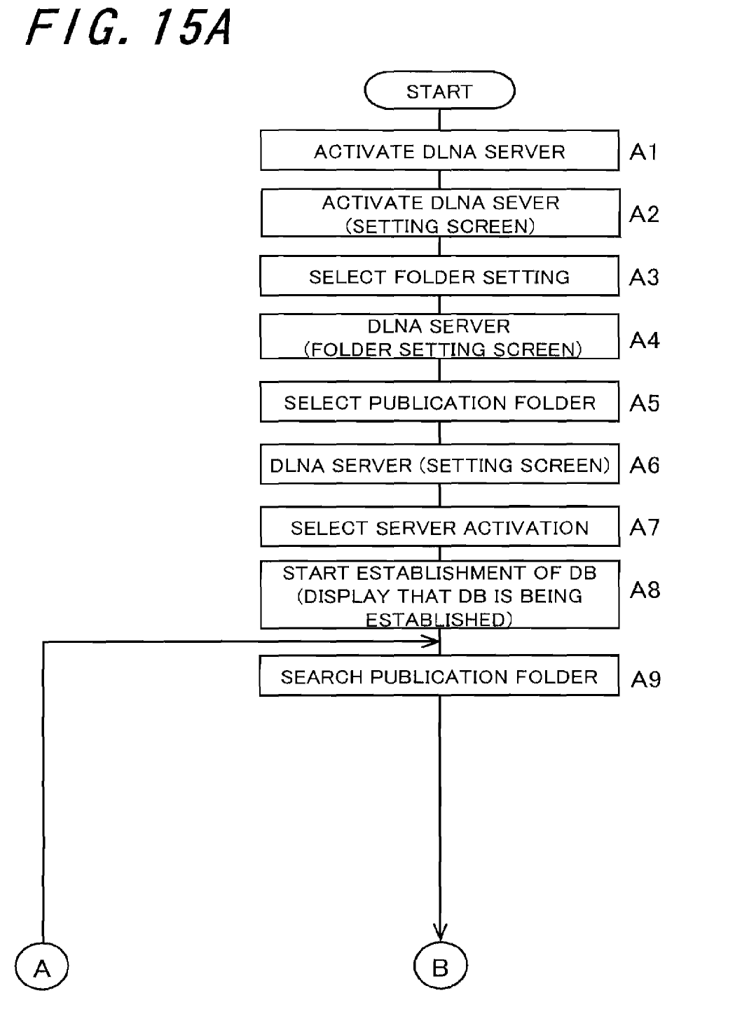

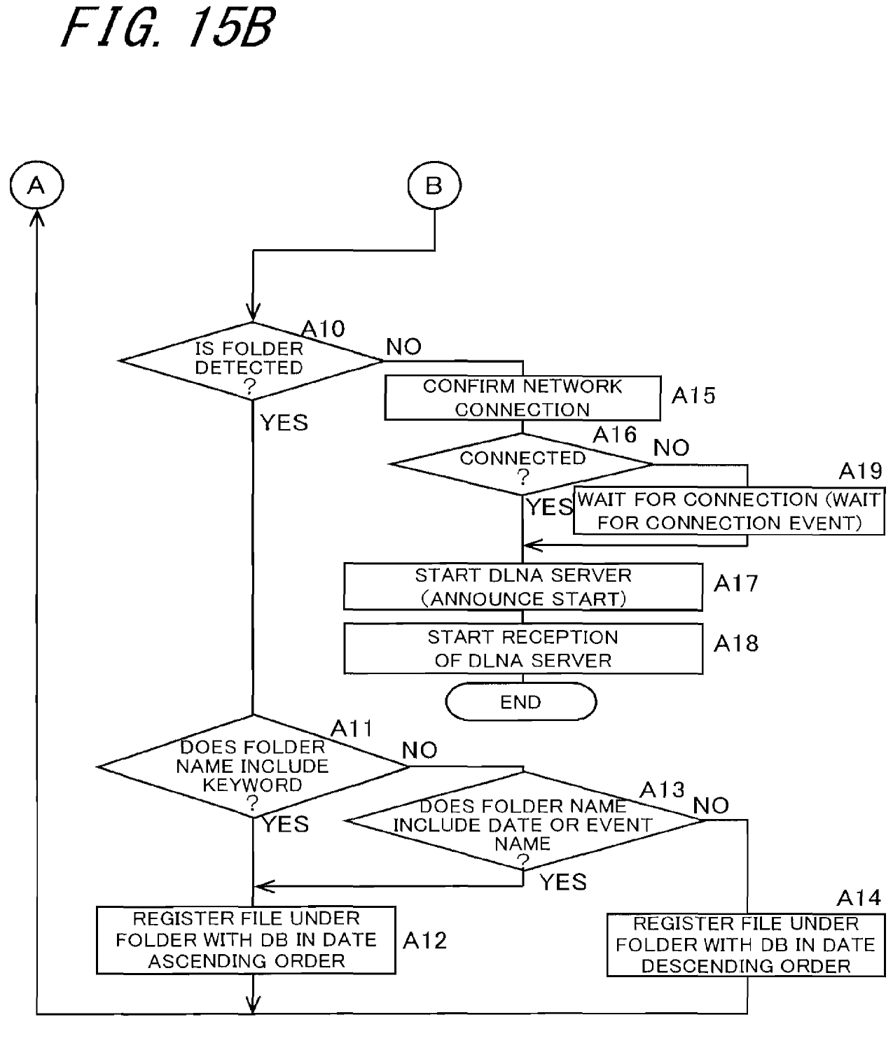

FIGS. 15A and 15B are flowcharts showing processing procedure of first DLNA setting processing executed by the mobile terminal 2. The first DLNA setting processing is such processing that a DB of publication files is created so that a publication file is able to be published to a DLNA client when a request is given from the DLNA client. When a user selects the item of the DLNA setting from the menu displayed on the first display section 23 of the mobile terminal 2, the flow moves to step A1.

At step A1, the DLNA server is activated. Specifically, a DLNA setting application included in the DLNA server is activated. At step A2, the DLNA setting application included in the activated DLNA server displays a DLNA setting screen, for example, the DLNA setting screen 41 shown in FIG. 7C on the first display section 23. At step A3, the user operates the operation section 29 to select folder setting. The folder setting is selected by selecting the item of the “PUBLICATION FOLDER SETTING” of the DLNA setting screen 41a shown in FIG. 7D by the operation section 29.

At step A4, the DLNA setting application, when the item of the “PUBLICATION FILE SETTING” is selected at step A3, displays a DLNA setting folder setting screen, for example, the DLNA setting folder setting screen 41b shown in FIG. 7D on the first display section 23. At step A5, the user operates the operation section 29 to select a publication folder. On the DLNA setting folder setting screen 41b, as publication folders to be selected, a name of a recording medium in which publication folders are recorded, for example, the “SD”, and a name of a storage apparatus in which publication folders are stored, for example, the “MAIN BODY” are displayed. The user selects a name of a publication folder including a publication file that is desired to be published from the displayed names, for example, the “SD” and the “MAIN BODY”.

At step A6, the DLNA setting application, when the publication folder is selected at step A5, displays a DLNA setting screen, for example, the DLNA setting screen 41c shown in FIG. 7C on the first display section 23. The DLNA setting application displays a name of the selected publication folder, for example, the “SD” in the item of the “PUBLICATION FOLDER SETTING” of the DLNA setting screen 41c. At step A7, the user operates the operation section 29 to select server operation. The server operation is to activate and operate the DLNA server. Specifically, the user selects the “ACTIVATION ON” in the item of the “ACTIVATION ON/OFF FLAG” of the DLNA setting screen 41d shown in FIG. 7E by the operation section 29 to select the server operation. When the item of the “ACTIVATION ON” is selected, the DLNA server is activated so that the DLNA server is in the operation state.

At step A8, the DLNA server starts establishment of a DB. At this time, a message showing that the DB is being established, for example, a message of “PREPARING DLNA, (DB) CREATING” is displayed on a center part of the DLNA setting screen 41e shown in FIG. 7E. At step A9, the DLNA server searches whether or not a folder is stored in the recording medium or the recording apparatus with the name of the publication folder set to the item of the “PUBLICATION FOLDER SETTING”. At step A10, the DLNA server judges whether or not the folder is searched. When the folder is detected, the flow goes to step A11, and when the folder is not detected, the flow goes to step A15.

At step A11, the DLNA server judges whether or not the folder name of the detected folder includes a keyword. When the keyword is included, the flow goes to step A12, and when the keyword is not included, the flow goes to step A13. At step A12, the DLNA server registers files under the detected folder, that is, files in the detected folder as publication files in the DB in the date ascending order, and after going back to step A9, repeats steps A9 to A14 for other folders. At step A13, the DLNA server judges whether or not the folder name includes a date or an event name. When the folder name includes a date or an event name, the flow goes to step A12, and when any of a date and an event name is not included, the flow goes to step A14. At step A14, the DLNA server registers files under the folder as publication files in the DB in the date descending order, and after going back to step A9, repeats steps A9 to A14 for other folders.

At step A15, the DLNA server confirms being connected to the network. Specifically, the DLNA server confirms that the first communication section 24 is in the state of being communicable with the network. At step A16, the DLNA server judges whether or not to be connected to the network. When the first communication section 24 is in the state of being communicable with the network, it is judged as being connected to the network and the flow goes to step A17, and when the first communication section 24 is not in the state of being communicable with the network, it is judged that the DLNA client is not being connected to the network and the flow goes to step A19.

At step A17, the DLNA server displays a message showing that the DLNA server is ready, for example, a message of “DLNA IS READY.” on a center part of the DLNA setting screen 41f shown in FIG. 7E, as well as starts processing for the DLNA client and notifies the DLNA client that the processing for the DLNA client is started. Upon reception of this notification, the DLNA client, for example, the display apparatus 3 registers the DLNA server that has given the notification in the server list.

At step A18, the DLNA server starts reception of a processing request from the DLNA client and completes the first DLNA setting processing. At step A19, the DLNA server waits for connection to the network, and when a connection event showing that connection is performed is informed, the flow goes to step A17. The connection event is an event for notifying the DLNA server that the first communication section 24 is connected to the network when the first communication section 24 becomes in the state of being communicable with the network.

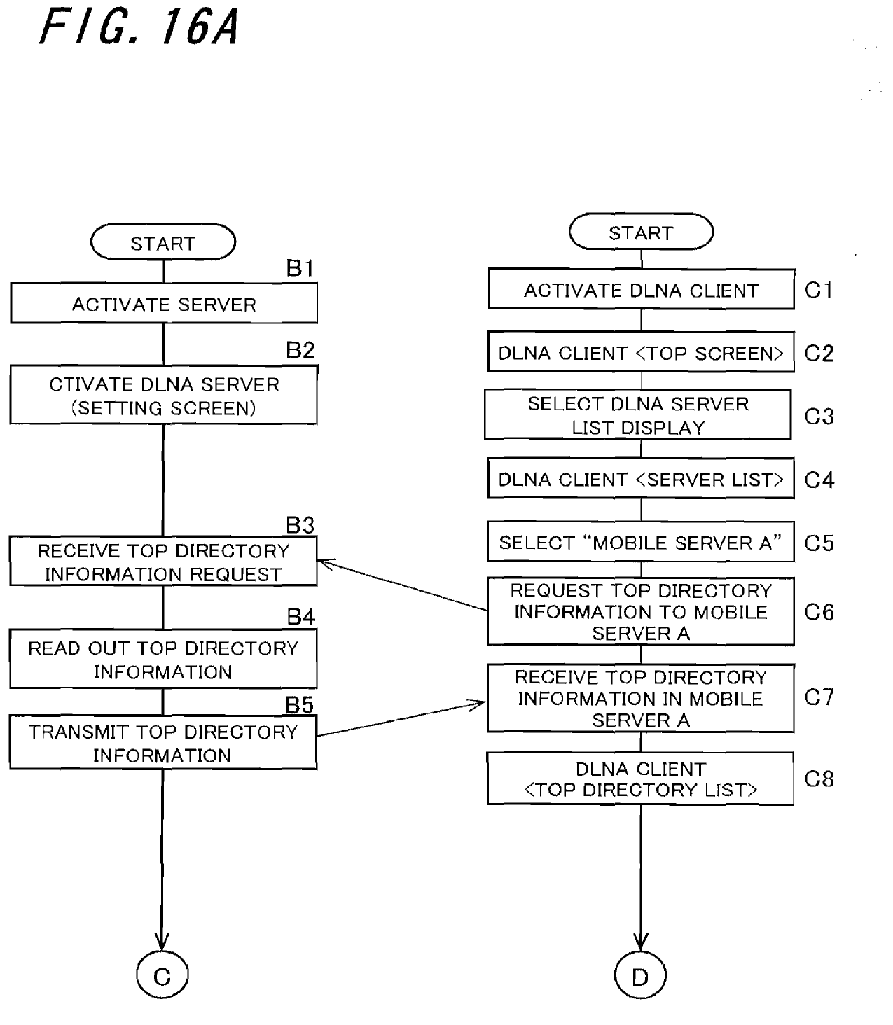

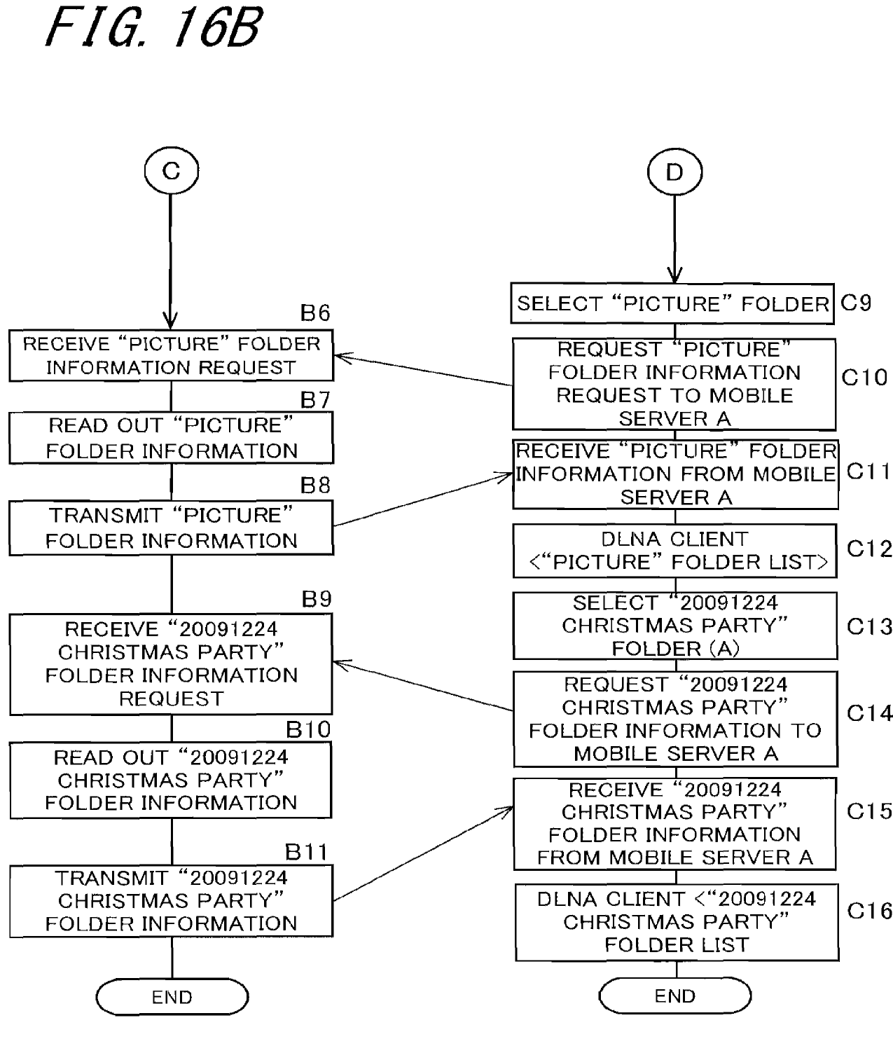

FIGS. 16A and 16B are flowcharts showing processing procedure of first content list transmission processing executed by the mobile terminal 2 and processing procedure of first content list request processing executed by the display apparatus 3, associated with each other. When the “ACTIVATION ON” of the item of the “ACTIVATION ON/OFF FLAG” is selected by the operation section 29 on the DLNA setting screen 41d shown in FIG. 7E, the DLNA server is activated, and the DLNA server moves to step B1. Moreover, when the item of the “3. DLNA” is selected by the remote controller 38 in the menu 611a displayed on the screen 611 shown in FIG. 9B, the DLNA client is activated and the DLNA client moves to step C1.

At step B1, the DLNA server is activated. At step B2, after establishment of a DB, the DLNA server displays the DLNA setting screen 41h shown in FIG. 7E to be in the operation state. At step B3, the DLNA server waits that the first communication section 24 receives a top directory information request from the DLNA client, and when the first communication section 24 receives the top directory information request from the DLNA client, goes to step B4. Top directory information refers to a top directory list indicating a list of folders in a top directory of a publication folder set to the item of the “PUBLICATION FOLDER SETTING”. The top directory information request is that the DLNA client requests transmission of the top directory list to the DLNA server. The top directory information request is a top directory information request transmitted at step C6, which will be described below, shown in FIG. 16A.

At step 34, the DLNA server reads the top directory information from the DB. Specifically, folder names of a second layer that is directly under a top layer are read from the DB, and a list of the folder names thus read is regarded as the top directory list, that is, the top directory information. At step B5, the DLNA server transmits the top directory information to the DLNA client by the first communication section 24.

At step B6, the DLNA server waits that the first communication section 24 receives from the DLNA client a folder information request of a folder name selected from the transmitted top directory list. Folder information refers to, when a folder with the folder name selected from the top directory list has folders, a folder list that is a list of folders in the folder, and when a folder with the folder name selected from the top directory list has no folders but files, refers to a content list that is a list of files in the folder. As folder information, the content list is also referred to as a folder list. The folder information request is that the DLNA client requests the DLNA server to transmit the folder list.

When the first communication section 24 receives the folder information request, for example, a “PICTURE” folder information request from the DLNA client, the DLNA server goes to step B7. The “PICTURE” folder information request is to request a folder list of folders in a folder with a folder name of “PICTURE”, and is the “PICTURE” folder information request transmitted at step C10 shown in FIG. 16B when the DLNA client selects “PICTURE” from folder names of folders in the top directory shown by the top directory information, for example, a folder name of “PICTURE” and a folder name of “CAMERA”. When the DLNA client selects “CAMERA” from the folder names of the folders in the top directory, a “CAMERA” folder information request is transmitted from the DLNA client.

At step B7, the DLNA server reads “PICTURE” folder information from the DB. Specifically, folder names of folders in the folder with the folder name of “PICTURE” are read from the DB and a list of folder names thus read serves as a folder list, that is, the “PICTURE” folder information. At step B8, the DLNA server transmits the “PICTURE” folder information to the DLNA client by the first communication section 24.

At step B9, the DLNA server waits that the first communication section 24 receives a folder information request. When the first communication section 24 receives a folder information request of a folder name selected by the remote controller 38, for example, a “20091224 CHRISTMAS PARTY” folder information request from the DLNA client, the DLNA server goes to step B10. The “20091224 CHRISTMAS PARTY” folder information is a folder list of folders in the folder with the folder name of “20091224 CHRISTMAS PARTY” selected from folder names of folders in the “PICTURE” folder from the DLNA client to the DLNA server. The “20091224 CHRISTMAS PARTY” folder information request is to request transmission of “20091224 CHRISTMAS PARTY” folder information, and is the “20091224 CHRISTMAS PARTY” folder information request transmitted at step C14 shown in FIG. 16B.

At step B10, the DLNA server reads the “20091224 CHRISTMAS PARTY” folder information from the DB. Specifically, since the folder with the folder name of “20091224 CHRISTMAS PARTY” has no folder, the DLNA server reads file names of files in the folder with the folder name of “20091224 CHRISTMAS PARTY” from the DB, and regards a list of the file names thus read as a folder list, that is, the “20091224 CHRISTMAS PARTY” folder information. At step B11, the DLNA server transmits the “20091224 CHRISTMAS PARTY” folder information to the DLNA client by the first communication section 24 and completes the first content list transmission processing.

At step C1, the DLNA client is activated. At step C2, the DLNA client displays a top screen, for example, the top screen 612 shown in FIG. 9C. At step C3, the user selects the item of “DLNA SERVER LIST DISPLAY”. The item of the “DLNA SERVER LIST DISPLAY” is, for example, the item 612a of “SELECT SERVER WITH RED BUTTON” displayed on the top screen 612 shown in FIG. 9C. By operating the red button of the remote controller 38, the user is able to select the item of the “DLNA SERVER LIST DISPLAY”. At step C4, the DLNA client displays a server list on a server selection screen, for example, the server selection screen 613 shown in FIG. 9D.

At step C5, the user selects a desired DLNA server, for example, the “MOBILE SERVER A” from the server list displayed on the server selection screen 613 by the remote controller 38. The mobile server A is the DLNA server of the mobile terminal 2. At step C6, the DLNA client transmits a top directory information request to the DLNA server selected by the remote controller 38, for example, the “MOBILE SERVER A” by the second communication section 34. At step C7, the DLNA client receives the top directory information request by the second communication section 34. The top directory information is the top directory information transmitted at step B5 shown in FIG. 16A.

At step C8, the DLNA client displays the directory information received from the DLNA server as a top directory list on a top directory screen, for example, the top directory screen 62 shown in FIG. 10A. At step C9, the user selects a desired folder, for example, a folder name of “PICTURE” from the displayed top directory list by the remote controller 38. At step C10, the DLNA client transmits a folder information request to request folder information of the selected folder name, for example, a “PICTURE” folder information request to the mobile server A by the second communication section 34.

At step C11, the DLNA client receives folder information of the folder name transmitted by the second communication section 34, for example, “PICTURE” folder information from the DLNA server by the second communication section 34. The “PICTURE” folder information is the “PICTURE” folder information transmitted at step B8 shown in FIG. 16B. At step C11, the DLNA client displays the “PICTURE” folder information received from the DLNA server as a “PICTURE” folder list. At step C13, the user selects a desired folder, for example, a file name of “20091224 CHRISTMAS PARTY” from the displayed “PICTURE” folder list by the remote controller 38. At step C14, the DLNA client transmits a folder information request to request folder information of the selected folder, for example, a “20091224 CHRISTMAS PARTY” folder information request to the mobile server A by the second communication section 34.

At step C15, the DLNA client receives folder information of the folder transmitted by the second communication section 34, for example, “20091224 CHRISTMAS PARTY” folder information from the DLNA server by the second communication section 34. This “20091224 CHRISTMAS PARTY” folder information is the “20091224 CHRISTMAS PARTY” folder information transmitted at step B11 shown in FIG. 16B. At step C16, the DLNA client displays the “20091224 CHRISTMAS PARTY” folder information received from the DLNA server as a “20091224 CHRISTMAS PARTY” folder list, for example, as displayed on the picture list display screen 621 shown in FIG. 10B, to complete the first content list request processing.

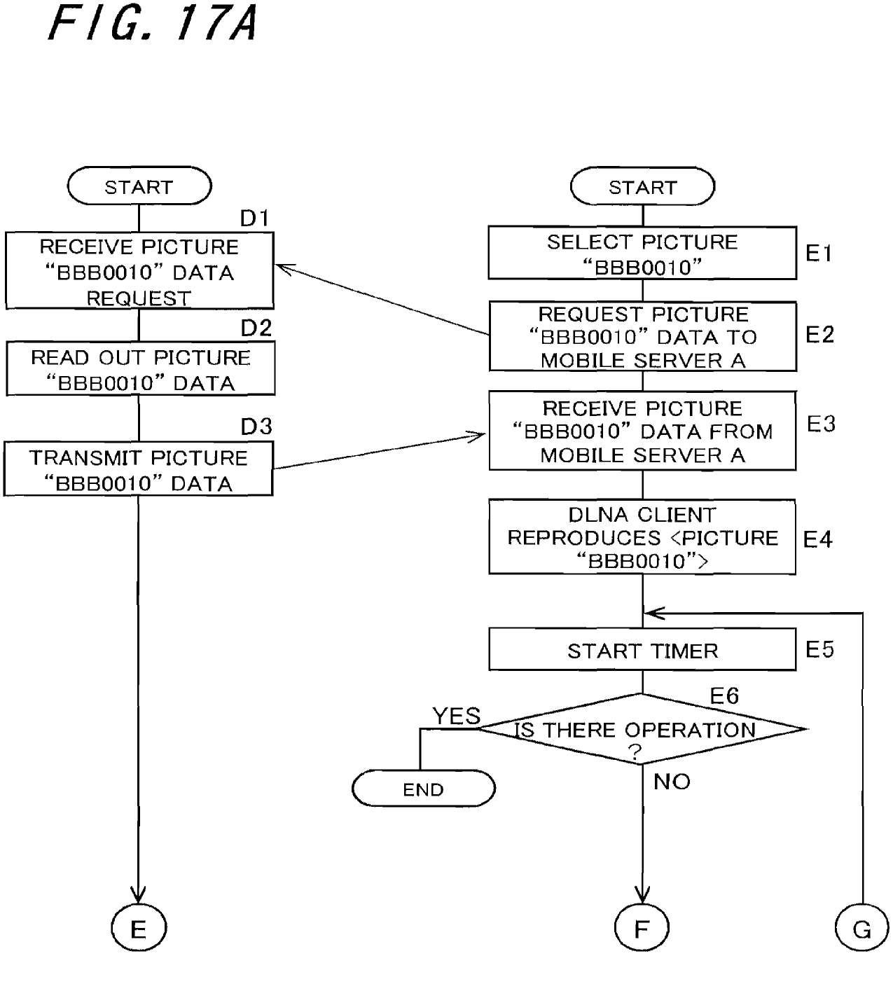

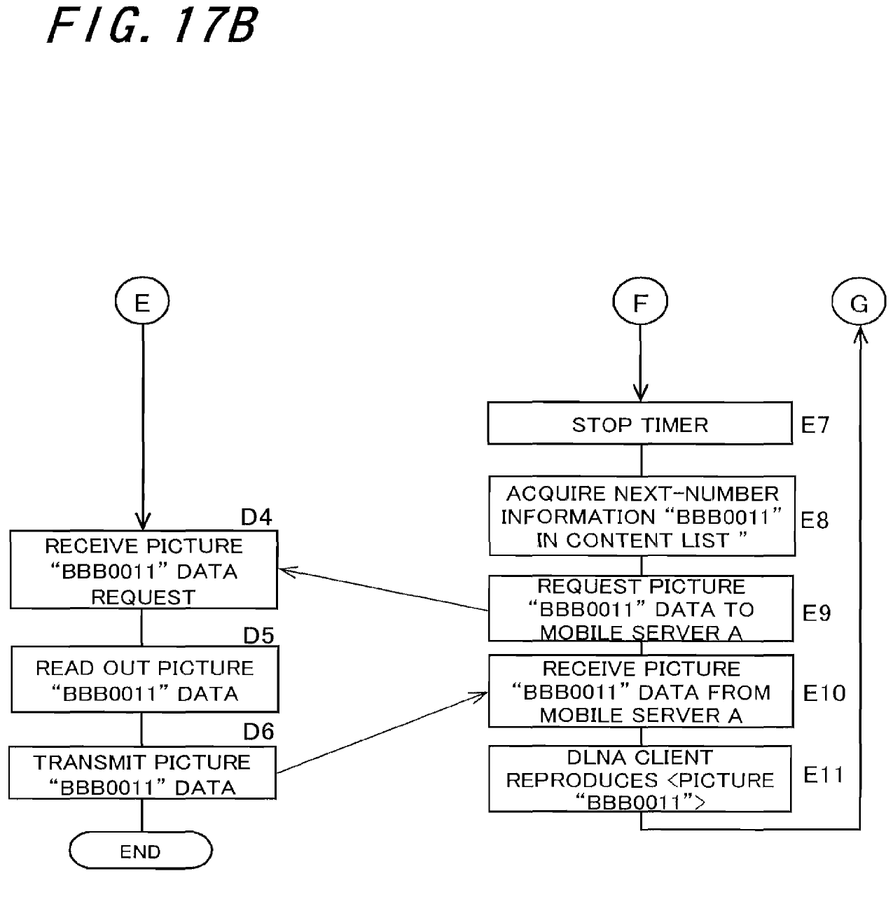

FIGS. 17A and 17B are flowcharts showing processing procedure of image transmission processing executed by the mobile terminal 2 and processing procedure of image display processing executed by the display apparatus 3, associated with each other. When the first content list transmission processing is completed at step B11 shown in FIG. 16B, the DLNA server moves to step D1. Alternatively, when the first content list request processing is completed at step C16 shown in FIG. 16B, the DLNA client moves to step E1.

At step D1, the DLNA server waits that the first communication section 24 receives a data request of a file name selected by the remote controller 38 from the DLNA client. The data request is to request transmission of data stored in a file with the file name selected by the remote controller 38. When the first communication section 24 receives the data request of the file name selected by the remote controller 38, for example, a picture “BBB0010” data request from the DLNA client, the DLNA server goes to step D2. The picture “BBB0010” data request is that the DLNA client requests the DLNA server to transmit image data of a file with a file name of “BBB0010”, and is the picture “BBB0010” data request transmitted at step E2 shown in FIG. 17A.

At step D2, the DLNA server reads image data stored in the file with the file name shown by the data request received by the first communication section 24 at step D1, for example, image data of the file with the file name of “BBB0010” from the SD card 4. At step D3, the DLNA server transmits the image data read at step D2, that is, the image data of the file with the file name of “BBB0010” as picture “BBB0010” data by the first communication section 24 to the DLNA client.

At step D4, the DLNA server waits that the first communication section 24 receives the data request of the file name selected by the remote controller 38 from the DLNA client. When the first communication section 24 receives the data request of the file name selected by the remote controller 38, for example, the picture “BBB0011” data request from the DLNA client, the DLNA server goes to step D5. The picture “BBB0010” data request is that the DLNA client requests the DLNA server to transmit image data of a file of a folder name of “BBB0011”, and is the picture “BBB0011” data request transmitted at step E10 shown in FIG. 17B.

At step D5, the DLNA server reads image data stored in the file of the file name shown by the data request received by the first communication section 24 at step D4, for example, image data of the file with the file name of “BBB0011” from the SD card 4. At step D6, the DLNA server transmits the image data read at step D5, that is, the image data of the file with the file name of “BBB0011” as picture “BBB0011” data by the first communication section 24 to the DLNA client, to complete the image transmission processing.

At step E1, the user selects a desired file name, for example, a file name of “BBB0010” by the remote controller 38 from a folder list of “20091224 CHRISTMAS PARTY” displayed on a picture list display screen, for example, the picture list display screen 621 shown in FIG. 10B. At step E2, the DLNA client transmits a data request of image data of the file with the file name selected at step E1, for example, the picture “BBB0010” data request that is the data request of the image data of the file with the file name of “BBB0010” to the DLNA server by the second communication section 34.

At step E3, the DLNA client receives picture “BBB0010” data from the mobile server A, that is, the DLNA server of the mobile terminal 2 by the second communication section 34. This picture “BBB0010” data is the picture “BBB0010” data transmitted at step D3 shown in FIG. 17A. At step E4, the DLNA client reproduces the picture “BBB0010” data received by the second communication section 34 at step E3. That is, the received picture “BBB0010” data, that is, an image of the image data of the file with the file name of “BBB0010” is displayed on the second display section 33, for example, as shown on the picture display screen 622 shown in FIG. 10C.

At step E5, the DLNA client starts a timer. Specifically, measurement of a predetermined time, for example, five seconds of time is started by time measurement means (not shown) such as a timer included in the display apparatus 3. At step E6, whether or not an operation is performed is judged. When there is no operation by the remote controller 38 after the timer has measured the predetermined time, the flow goes to step E7, and when there is an operation by the remote controller 38 before the timer has measured the predetermined time, the flow moves to processing corresponding to the operation. When the operation is an operation by the right cursor key, the flow goes to step E8 to display a next picture, and when the operation is an operation by the back key, the flow goes back to step C16 to display a content list, for example, the “20091224 CHRISTMAS PARTY” folder list, for example, as shown on the picture list display screen 621 shown in FIG. 10B.

At step E7, the DLNA client stops the timer. Specifically, measurement of time by the time measurement means (not shown) is stopped. At step E8, the DLNA client acquires next-number information, for example, “BBB0011” from the content list, for example, the “20091224 CHRISTMAS PARTY” folder list. The “BBB0011” refers to the file name of “BBB0011”. At step E9, the DLNA client transmits a picture “BBB0011” data request that is a data request of the next-number information acquired at step E8, for example, the image data of the file with the file name of “BBB0011” to the DLNA server by the second communication section 34.

At step E10, the DLNA client receives picture “BBB0011” data from the mobile server A by the second communication section 34. This picture “BBB0011” data is the picture “BBB0011” data transmitted at step D6 shown in FIG. 17B. At step E11, the DLNA client reproduces the picture “BBB0011” data received by the second communication section 34 at step E10. That is, an image of the received picture “BBB0011” data, that is, image data of the file with the file name of “BBB0010” is displayed on the second display section 33 as shown on the picture display screen 623 shown in FIG. 10D, and the flow goes back to step E5. Steps D1 to D6 and steps E1 to E11 shown in FIGS. 17A and 17B are publishing steps.

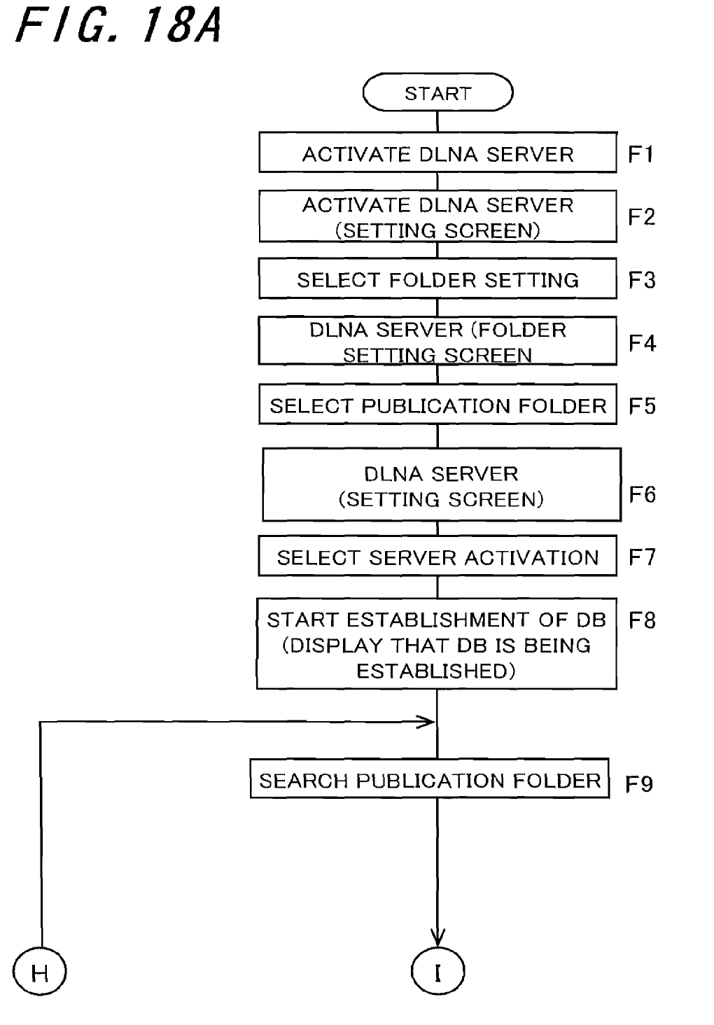

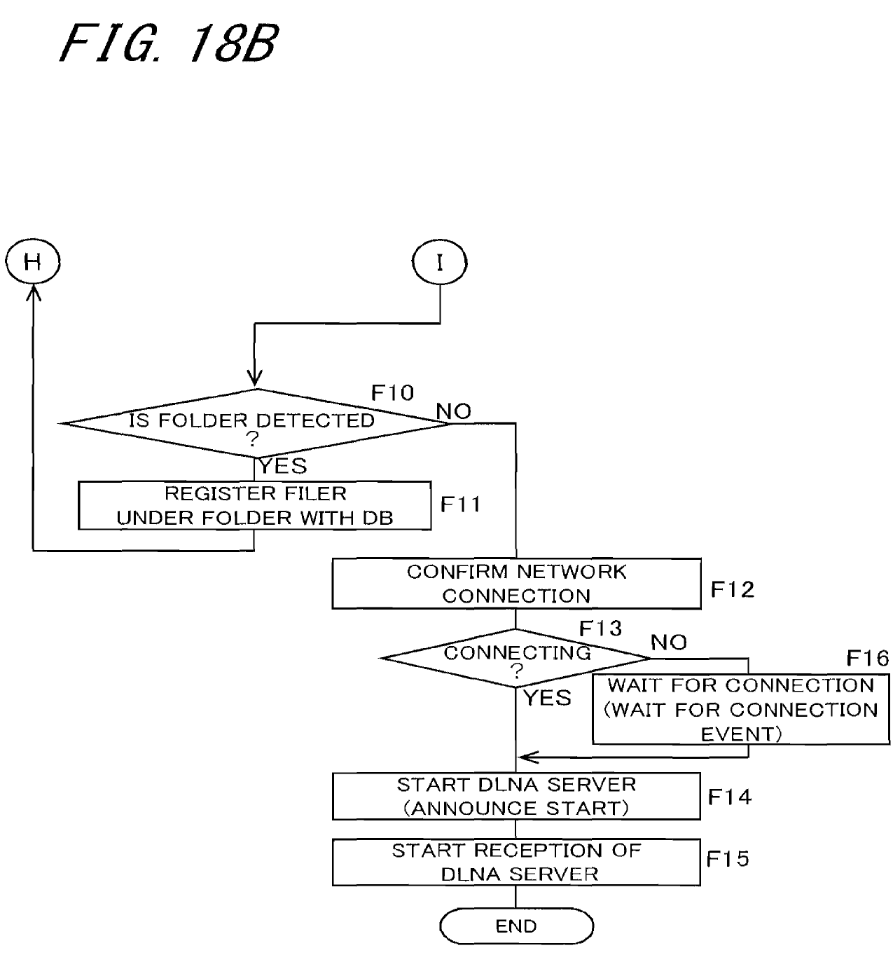

FIGS. 18A and 18B are flowcharts showing processing procedure of second DLNA setting processing executed by the mobile terminal 2. In the first DLNA setting processing shown in FIGS. 15A and 15B, when a file name is registered in the DB, the registering order is determined based on a folder name, whereas in the second DLNA setting processing, when a file name is registered in the DB, the registration is performed in the same order as the order recorded in a recording medium such as an SD or the order stored in a storage apparatus such as a main body. When a content list is created in response to a request from the DLNA client, then the content list is created in publishing order registered in the DB.

When the user selects the item of DLNA setting from the menu displayed on the first display section 23 of the mobile terminal 2, the flow moves to step F1. For each processing of steps F1 to F10 and F12 to F16, the same processing as each processing of steps A1 to A10 and A15 to A19 shown in FIGS. 15A and 15B is performed, respectively, so that explanation will be omitted to avoid duplication.

At step F11, the DLNA server registers files under the detected folder, that is, files in the detected folder in the DB as publication files, and the flow goes back to step F9 to repeat steps F9 to F11 for other folders. Specifically, the DLNA server registers file names of the files in the DB in the same order as the order that the files are recorded in a recording medium such as an SD or the order that the files are stored in a storage apparatus such as a main body. The order that the files are recorded in a recording medium such as an SD or the order that the files are stored in a storage apparatus such as a main body refers to the order of a directory structure of a recording medium such as an SD or a storage apparatus such as a main body, for example, the directory structure 50 shown in FIG. 8.

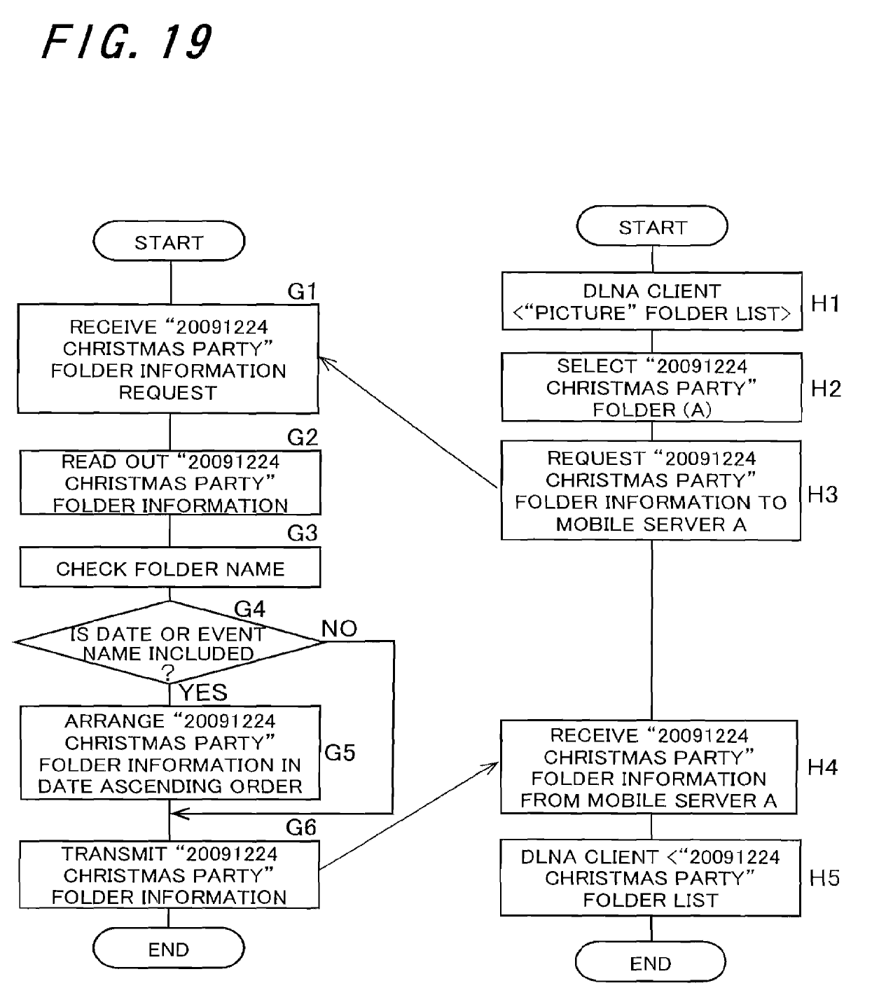

FIG. 19 is a flowchart showing processing procedure of second content list transmission processing executed by the mobile terminal 2 and processing procedure of second content list request processing executed by the display apparatus 3, associated with each other. The second content list request processing and the second content list transmission processing are the processing executed when the DB is set at the second DLNA setting processing shown in FIGS. 18A and 18B, in which when a request to transmit a content list is given from the DLNA client, the DLNA server creates the content list in publishing order registered in the DB.

Steps B1 to B8 of the first content list transmission processing shown in FIGS. 16A and 16B are also executed in the second content list transmission processing, which will be omitted in FIG. 19. In the second content list request processing, after step B8 of the first content list transmission processing is executed, the flow moves to step G1. For each processing of steps G1, G2 and G6, the same processing as each processing of steps B9 to B11 shown in FIG. 16B is performed, respectively, so that explanation will be omitted to avoid duplication.

At step G3, the DLNA server checks a folder name. Specifically, the DLNA server checks whether or not a folder name of a folder information request received at step G1 includes a date or an event name. At step G4, the DLNA server judges whether or not the folder names includes a date or an event name. When the folder name includes a date or an event name, the flow goes to step G5, and when the folder name does not include any of a date and an event name, the flow goes to step G6. At step G5, the DLNA server arranges file names of “20091224 CHRISTMAS PARTY” folder information that is a content list serving as a list of file names read at step G2, for example, a content list serving as a list of file names of files in a folder with a folder name of “20091224 CHRISTMAS PARTY”, in the date ascending order.

In addition, steps C1 to C11 of the first content list request processing shown in FIGS. 16A and 16B are also executed in the second content list request processing, which will be omitted in FIG. 19. After step C11 of the first content list request processing is executed, the flow moves to step H1. In the second content list request processing, for each processing of steps H1 to H5, the same processing as each processing of steps C12 to C16 shown in FIG. 16B is performed, respectively, so that explanation will be omitted to avoid duplication. Steps C12 to C14 shown in FIG. 16B or steps H1 to H3 shown in FIG. 19 are selection steps. Steps B9 to B11 shown in FIG. 16B and steps G1 to G6 shown in FIG. 19 are generation steps.

In this manner, the embodiments described above are configured such that the mobile terminal 2 creates a content list based on a DB to transmit to the display apparatus 3, and the display apparatus 3 displays the content list received from the mobile terminal 2, in which the display apparatus 3 does not need to create the content list from the DB. Since processing capability of the display apparatus 3 such as a television apparatus is lower than processing capability of a personal computer, creating the content list by the display apparatus 3 imposes a heavy burden on the second CPU 30 to hinder processing with high priority. The processing capability is, for example, a processing speed of a CPU as well as a storage capacity and an access speed of a temporal storage section.

In addition, when file names are registered in publishing order at the time of creating a DB, arrangement is not necessary at the time of creating a content list, so that it is possible to create the content list in a short time. However, when the DB is shared with other APP that is not able to arrange file names, for example, an application such as a photo viewer, arrangement at the time of creating the content list makes it possible to share the DB with the other APP.

Further, as to picture files that are files of image data of pictures, when sorting shot ones, ones having the same theme or the same event are generally collected for each folder. The picture file is a file of image data of a picture. In the image display system 1, when a plurality of picture files in the folder sorted in this manner, specifically, the folder including a date or an event name such as a Christmas party are browsed by an operation of the remote controller on a television apparatus connected to a network, it is possible to display from a picture that is shot at the beginning of the Christmas party in shooting order on a full screen of the television apparatus without selecting one by one on the television apparatus or setting displaying order in advance.

When seeing pictures that are not sorted for each folder, by performing display on the television apparatus following from new one sequentially, it is possible to perform browsing in similar order to the case when the operation is performed by the mobile terminal 2, which is useful for the case of finding a target one and the like.

In addition, by naming a folder name in accordance with a predetermine naming rule, for example, by including a keyword for control in a folder name, it is possible to specify displaying order and listing order of files to be published as the date ascending order, the date descending order, or the order of Japanese syllabary, thus making it possible to publish on the network in the order in accordance with file characteristics.

In the embodiments described above, the publishing order registered when the DLNA server creates a DB in the mobile terminal 2 is set in advance before a product is shipped, and is fixed after the product is shipped. In order to make it possible to change registration of publishing order in a DB even after the product is shipped, for example, for each manufacturer identification information for identifying a manufacturer of the mobile terminal 2, publishing order information that determines publishing order for a date, an event name or a keyword included in a folder name is generated in advance and stored in the first storage section 21 with a program of the DLNA server. The DLNA server may then read the manufacturer identification information of the mobile terminal 2 from hardware of the mobile terminal 2, for example, the first storage section 21 at the time of creating the DB and register publishing order based on publishing order information corresponding to the read manufacturer identification information in the DB.

Instead of the manufacturer identification information of the mobile terminal 2, it is also possible to use manufacturer identification information of a manufacturer of a program of a DLNA client embedded in the display apparatus 3. In this case, the manufacturer identification information is acquired from the display apparatus 3.

In the embodiments described above, the program executed by the first CPU 20 is stored in the first storage section 21 and, in execution, read from the first storage section 21 and stored in the first temporal storage section 22, while the program executed by the second CPU 30 is stored in the second storage section 31 and, in execution, read from the second storage section 31 and stored in the second temporal storage section 32. However, the place in which the program is stored is not limited to storage apparatuses such as the first storage section 21 and the second storage section 31, and it may be configured so that the program is recorded in a computer readable recording medium such as the first CPU 20 and the second CPU 30 and, in execution, read from this recording medium and stored in the first temporal storage section 22 and the second temporal storage section 32. The recording medium may be a recording medium capable of being read by providing a program reading apparatus as an external storage apparatus (not shown) and inserting the recording medium therein, or may be a storage apparatus of other apparatus.

Each recording medium may have any configuration as far as the stored program is accessed from a computer and executed. In addition, each recording medium may have any configuration as far as the program is read, the read program is stored in the first temporal storage section 22 and the second temporal storage section 32, and the program is executed. Further, the program may be downloaded from other apparatus through a communication network and stored in the first temporal storage section 22 and the second temporal storage section 32. The program for download is stored in the first temporal storage section 22 and the second temporal storage section 32 in advance or installed in the first temporal storage section 22 and the second temporal storage section 32 from a separate recording medium.

A recording medium configured to be capable of being separated from the main body may be, for example, a recording medium of a tape type such as a magnetic tape/cassette tape, a recording medium of a disk type such as magnetic disk including a flexible disk/hard disk and the like and optical disks including CD-ROM (Compact Disk Read Only Memory)/MO(Magneto Optical disk)/MD (Mini Disc)/DVD (Digital Versatile Disk) and the like, a recording medium of a card type such as an IC (Integrated Circuit) card (including a memory card)/optical card, or a recording medium that fixedly carries a program including semiconductor memories such as a mask ROM/EPROM (Erasable Programmable Read Only Memory)/EEPROM (Electrically Erasable Programmable Read Only Memory)/flash ROM. Accordingly, the invention is able to be provided as a computer readable recording medium having a program for causing a computer to execute each step of an image display method recorded therein.

In this manner, the first temporal storage section 22 stores a plurality of publication data sets to be published by the display apparatus 3 that publishes publication data, associated with a file name for identifying the plurality of publication data sets so that the plurality of publication data sets are sorted into a plurality of folders to which individual folder names are applied, as well as stores folder names of the respective folders. The first CPU 20 and the first communication section 24 read folder names stored in the first temporal storage section 22 and transmit the read folder names to the display apparatus 3. The first CPU 20 and the first communication section 24 receive a folder name selected from the folder names transmitted by the first CPU 20 and the first communication section 24 from the display apparatus 3. The first CPU 20 reads file names of publication data sets sorted into a folder shown by the folder name received by the first CPU 20 and the first communication section 24 from the first temporal storage section 22, and generates a content list in which the read file names are arranged in accordance with publishing order determined based on the received folder name. Then, the first CPU 20 and the first communication section 24 transmit the content list generated by the first CPU 20 to the display apparatus 3.

Accordingly, it is possible to control publishing order of publication data sets in accordance with information included in folder identification information such as a folder name, thus making it possible to change publishing order easily when data of an image or the like is published to other apparatus connected to the network.

Further, the first temporal storage section 22 stores time and date information indicating times and dates when the respective publication data sets are generated. Folder names stored in the first temporal storage section 22 include a folder name including a date when publication date is generated and a folder name not including a date. Then, the first CPU 20, when the received folder name includes a date, generates a content list in which file names are arranged in ascending order of times and dates shown by time and date information stored in the first temporal storage section 22, and when the received folder name does not include a date, generates a content list in which file names are arranged in descending order of times and dates shown by time and date information stored in the first temporal storage section 22. Accordingly, by including a folder name, for example, a date, for example, a year-month-day in a folder name, it is possible to display publication data sets included in the folder in generating order.

Further, the first temporal storage section 22 stores time and date information indicating times and dates when the respective publication data sets are generated. Folder names stored in the first temporal storage section 22 include a folder name including an event name indicating a name of an event and a folder name not including an event name. Then, the first CPU 20, when the received folder name includes an event name, generates a content list in which file names are arranged in ascending order of times and dates shown by time and date information stored in the first temporal storage section 22, and when the received folder name does not include an event name, generates a content list in which file names are arranged in descending order of times and dates shown by time and date information stored in the first temporal storage section 22. Accordingly, by including an event name in folder identification information such as a folder identification information folder name, it is possible to display publication data sets included in the folder in generating order and the story line is not failed.

Further, folder names stored in the first temporal storage section 22 include a folder name including a keyword and a folder name not including a keyword. The first CPU 20, when the received folder name includes a keyword, generates a content list in which file names are arranged in publishing order determined based on the keyword, so that by including folder identification information such as a folder name in the keyword, it is possible to display publication data sets included in the folder in generating order or in reverse generating order.

Further, the first temporal storage section 22 stores manufacturer identification information for identifying manufacturers that produced mobile terminal apparatuses. In addition, publishing order determined based on the received folder name is set based on the manufacturer identification information stored in the first temporal storage section 22, thus making it possible to perform display in different displaying order for each mobile terminal 2 with different manufacturer.

Further, publication data sets stored in the first temporal storage section 22 include image data indicating an image. In addition, the photo viewer displays image data sorted into a folder shown by a folder name selected from folder names stored in the first temporal storage section 22 in arranging order determined based on a predetermined basis different from the publishing order determined based on the received folder name, for example, the date descending order. Accordingly, it is possible to set displaying order of an image display section such as the photo viewer independently.

Further, when information is published in the image display system 1 including the display apparatus 3 that publishes data and the mobile terminal 2 that stores a plurality of publication data sets to be published by the display apparatus 3, associated with a file name for identifying the plurality of publication data sets so that the plurality of publication data sets are sorted into a plurality of folders to which individual folder names are applied, as well as stores folder names of the respective folders, the display apparatus 3 displays folder information stored in the mobile terminal 2 and selects a folder name of a folder to be published from folder names displayed. The mobile terminal 2 generates a content list in which file names of publication data sets sorted into the folder shown by the folder name selected by the display apparatus 3 are arranged in accordance with publishing order determined based on the selected folder name. Then, the display apparatus 3 sequentially publishes the publication data sets in the publishing order arranged in the content list generated by the mobile terminal 2.

Accordingly, it is possible to control publishing order of publication data sets in accordance with information included in folder identification information such as a folder identification information folder name, thus making it possible to change publishing order easily when data of an image or the like is published to other apparatus connected to the network.

Further, when information is published in the image display system 1 including the display apparatus 3 that publishes data and the mobile terminal 2 that stores a plurality of publication data sets to be published by the display apparatus 3, associated with a file name for identifying the plurality of publication data sets so that the plurality of publication data sets are sorted into a plurality of folders to which individual folder names are applied, as well as stores folder names of the respective folders, at steps C12 to C14 shown in FIG. 16B or steps H1 to H3 shown in FIG. 19, the display apparatus 3 displays folder information stored in the mobile terminal 2 and selects a folder name of a folder to be published from folder names displayed. At steps B9 to B11 shown in FIG. 16B or steps G1 to G6 shown in FIG. 19, the mobile terminal 2 generates a content list in which file names of publication data sets sorted into the folder shown by the folder name selected at step C12 to C14 shown in FIG. 16B or steps H1 to H3 shown in FIG. 19 are arranged in accordance with publishing order determined based on the selected folder name. Then, at step D1 to D6 and steps E1 to E11 shown in FIGS. 17A and 17B, the display apparatus 3 sequentially publishes the publication data sets in the publishing order arranged in the content list generated at steps B9 to B11 shown in FIG. 16B or steps G1 to G6 shown in FIG. 19.

Accordingly, it is possible to control publishing order of publication data sets in accordance with information included in folder identification information such as a folder name, thus making it possible to change publishing order easily when data of an image or the like is published to other apparatus connected to the network.

Further, it is possible to provide as a computer readable recording medium having a program recorded therein for causing the first CPU 20 and the second CPU 30 included in the image display system 1 including the second display section 33 that publishes data, the first temporal storage section 22 that stores a plurality of publication data sets to be published by the second display section 33, associated with a file name for identifying the plurality of publication data sets so that the plurality of publication data sets are sorted into a plurality of folders to which individual folder names are applied as well as stores a folder name of the respective folders, the first CPU 20, and the second CPU 30, to execute a selection step of displaying folder information stored in the first temporal storage section 22 and selecting a folder name of a folder to be published from displayed folder names, a generation step of generating a content list in which file names of publication data sets sorted into a folder shown by the folder name selected at the selection step are arranged in accordance with publishing order determined based on the selected folder name, and a publication step of publishing the publication data sets sequentially on the second display section 33 in the publishing order arranged in the content list generated at the generation step.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A mobile terminal apparatus, comprising:
a storage section that stores a plurality of output data sets to be outputted by an output apparatus for outputting data, associated with output data identification information for identifying the plurality of output data sets so that the plurality of output data sets are sorted into a plurality of folders to which individual folder identification information are added, as well as stores folder identification information of the respective folders;
a first transmitting section that reads folder identification information stored in the storage section and transmits the read folder identification information to the output apparatus;
a receiving section that receives folder identification information selected from among the folder identification information transmitted by the first transmitting section from the output apparatus;
a generating section that reads output data identification information of the output data sets sorted into a folder shown by the folder identification information received by the receiving section and generates an output data list in which the read output data identification information is arranged in accordance with arranging order determined based on received folder identification information; and
a second transmitting section that transmits the output data list generated by the generating section to the output apparatus.

2. The mobile terminal apparatus according to claim 1, wherein
the storage section stores time and date information indicating times and dates when the respective output data sets are generated,
the folder identification information stored in the storage section has folder identification information including date information indicating a date when an output data set is generated and folder identification information not including date information, and
when the received folder identification information includes date information, the generating section generates an output data list in which the output data identification information is arranged in ascending order of times and dates shown by the time and date information stored in the storage section,
and when the received folder identification information does not include date information, the generating section generates an output data list in which the output data identification information is arranged in descending order of times and dates shown by the time and date information stored in the storage section.

3. The mobile terminal apparatus according to claim 1, wherein
the storage section stores time and date information indicating times and dates when the respective output data sets are generated,
the folder identification information stored in the storage section has folder identification information including event name information indicating an event name and folder identification information not including event name information, and
when the received folder identification information includes event name information, the generating section generates an output data list in which the output data identification information is arranged in ascending order of times and dates shown by the time and date information stored in the storage section,
and when the received folder identification information does not include event name information, the generating section generates an output data list in which the output data identification information is arranged in descending order of times and dates shown by the time and date information stored in the storage section.

4. The mobile terminal apparatus according to claim 1, wherein
the folder identification information stored in the storage section has folder identification information including keyword information indicating a keyword and folder identification information not including keyword information, and
when the received folder identification information includes keyword information, the generating section generates an output data list in which the output data identification information is arranged in arranging order determined based on the keyword information.

5. The mobile terminal apparatus according to claim 1, wherein
the storage section stores manufacturer identification information for identifying manufacturers that produced mobile terminal apparatuses, and
arranging order determined based on the received folder identification information is set based on the manufacturer identification information stored in the storage section.

6. The mobile terminal apparatus according to claim 1, wherein
the output data set stored in the storage section includes image data indicating an image,
the mobile terminal apparatus further comprising:
an image display section that displays image data sorted into a folder indicated by folder identification information selected from the folder identification information stored in the storage section in arranging order determined based on a predetermined basis that is different from the arranging order determined based on the received folder identification information.

7. An information output system, comprising:
an output apparatus that outputs data; and
a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders,
the output apparatus displaying the folder information stored in the mobile terminal apparatus and selecting folder identification information of a folder to be outputted from the displayed folder identification information,
the mobile terminal apparatus generating an output data list in which output data identification information of the output data sets sorted into the folder shown by the folder identification information selected by the output apparatus in accordance with arranging order determined based on the selected folder identification information, and
the output apparatus sequentially outputting the output data sets in arranging order arranged in the output data list generated by the mobile terminal apparatus.

8. An information output method executed in an information output system including an output apparatus that outputs data, and a mobile terminal apparatus that stores a plurality of output data sets to be outputted by the output apparatus, associated with output data identification information for identifying the plurality of output data sets so that the plurality of output data sets are sorted into a plurality of folders to which individual folder identification information are added, as well as stores folder identification information of the respective folders, comprising:
a selection step where the output apparatus displays folder information stored in the mobile terminal apparatus and selects folder identification information of a folder to be outputted from the displayed folder identification information;
a generation step where the mobile terminal apparatus generates an output data list in which output data identification information of the output data sets sorted into the folder shown by the folder identification information selected at the selection step is arranged in accordance with arranging order determined based on the selected folder identification information; and
an output step where the output apparatus sequentially outputs the output data sets in arranging order arranged in the output data list generated at the generation step.

9. A computer readable recording medium having a program recorded therein for causing a computer included in an information output system including an output section that outputs data, a storage section that stores a plurality of output data sets to be outputted by the output section, associated with output data identification information for identifying the plurality of output data sets so that the plurality of output data sets are sorted into a plurality of folders to which individual folder identification information are added, as well as stores folder identification information of the respective folders, and the computer, to execute:
a selection step of displaying folder information stored in the storage section and selecting folder identification information of a folder to be outputted from the displayed folder identification information;
a generation step of generating an output data list in which output data identification information of the output data sets sorted into the folder shown by the folder identification information selected at the selection step is arranged in accordance with arranging order determined based on the selected folder identification information; and
an output step of sequentially outputting the output data sets in arranging order arranged in the output data list generated at the generation step on the output section.
